(19) United States
(12) Patent Application Publication
(10) Pub. No.: US 2023/0153913 A1
(43) Pub. Date: May 18, 2023

(54) METHOD AND SYSTEM FOR ESTIMATING A RESTORATION COST OF A LOSS SITE

(71) Applicants: Jose Ceja, Chino, CA (US); John Charles Horst, Escondido, CA (US)

(72) Inventors: Jose Ceja, Chino, CA (US); John Charles Horst, Escondido, CA (US)

(21) Appl. No.: 17/985,840

(22) Filed: Nov. 12, 2022

Related U.S. Application Data
(60) Provisional application No. 63/278,985, filed on Nov. 12, 2021.

(51) Int. Cl. G06Q 40/08

(52) U.S. Cl. CPC G06Q 40/08

(57) ABSTRACT

Disclosed herein is a method of estimating the restoration cost of a loss site that includes obtaining an inspection data from the loss site, comprising data representing an inventory of at least a portion of articles present at the loss site; determining from these data a classification for each of the plurality of articles identified in the inventory according to predetermined classification criteria; and generating an estimated site restoration cost for the loss site based at least partially on the classifications of each of the plurality of articles. Systems suitable for conducting the method are also disclosed.

### CROSS REFERENCE TO RELATED PATENT APPLICATIONS

This patent application claims the priority and benefit, under 35 U.S.C. § 119(e), of U.S. Provisional Patent Application Ser. No. 63/278,985, filed Nov. 12, 2021, entitled “METHOD AND SYSTEM FOR ESTIMATING A RESTORATION COST OF A LOSS SITE”. U.S. Provisional Patent Application Ser. No. 63/278,985 is herein incorporated by reference in its entirety.

### TECHNICAL FIELD

Embodiments are generally related to the field of insurance. Embodiments are also related to the field of loss estimating tools. Embodiments are further related to the field of computer devices and mobile devices used for evaluating a loss site. Embodiments are also related to methods, systems, and devices for estimating a restoration cost of a loss site.

### BACKGROUND

The statements in this section merely provide background information related to the present disclosure and may not constitute prior art.

Property may be damaged by a number of natural and man-made phenomena, requiring restoration to restore the property to a functional and/or pre-loss state. Typical causes of such damage include fire, flooding, and the like. In order to provide restoration, quotes for the needed activities must be obtained, which are then submitted to insurers of the property, or provided to the owner. Obtaining restoration quotes of a loss site typically require a physical inspection by at least one inspector.

On-site inspections have inherent costs, whether such inspections are performed by an insurance company, employee, or a third-party contractor. Physical inspections also expose company and contract adjustors to risks of personal injury or death, particularly at property locations that have suffered significant damage. Accordingly, it is paramount to the success of the restoration process that the inspection be conducted in as thorough and inclusive a manner as possible.

However, inspectors often are limited by time and are subject to the effects of chaos and destruction inherent in such situations. Conducting an effective assessment at a loss site and producing an accurate quote for conducting a restoration process at the loss site requires understanding the steps required and the cost of each step in a myriad of interrelated activities, along with ancillary costs which are not often readily apparent to the untrained or inexperienced eye. Conducing an effective and thorough inspection of a loss site and producing an accurate, reasoned, and defensible quote for conducting a restoration process at the loss site often requires decades of experience on the part of the inspector.

Accordingly, a need exists in the art for a method and system for obtaining restoration quotes for a loss site which represent an accurate assessment of the cost of conducting all facets of a restoration process, which may be conducted by an inspector regardless of his/her level of experience or other situational factors. There is also a need for estimating the loss based on data and photos, as further detailed herein.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide improved methods and systems for insurance and estimates associated with a loss site.

It is another aspect of the disclosed embodiments to provide a method, system, and apparatus for computer devices and mobile devices used for evaluating a loss site.

It is another aspect of the disclosed embodiments to provide methods, systems, devices, and apparatuses for estimating a restoration cost of a loss site.

In embodiments, a method of estimating a partial or total restoration cost of a loss site, and content therein, comprises the steps of obtaining inspection data from the loss site and/or a list comprising at least one of chargeable activities and/or chargeable articles associated with restoration at the loss site, comprising data representing an inventory of at least a portion of articles present at the loss site; determining from these data a classification for each of the plurality of articles identified in the inventory according to predetermined classification criteria; and generating an estimated site restoration cost for the loss site based at least partially on the classifications of each of the plurality of articles.

In embodiments, a system for estimating a restoration cost of contents of a loss site comprises a computerized inspection system configured to present a series of questions to an inspector and receive answers from the inspector, to produce inspection data from the loss site comprising data representing an inventory of at least a portion of articles present at the loss site, which is further configured to determine from these data a classification for each of the plurality of articles identified in the inventory according to predetermined classification criteria; and generate an estimated site restoration cost for the loss site based at least partially on the classifications of each of the plurality of articles.

in certain embodiments, a system comprises a computer system, the computer system further comprising: at least one processor; a graphical user interface; and a computer-usable medium embodying computer program code, the computer-usable medium capable of communicating with the at least one processor, the computer program code comprising instructions executable by the at least one processor and configured for: receiving inspection data from a loss site, comprising data representing an inventory of at least a portion of articles present at the loss site, determining from these data a classification for each of the plurality of articles identified in the inventory according to predetermined classification criteria, and generating an estimated restoration cost for the loss site based at least partially on the classifications of each of the plurality of articles.

In an embodiment the system further comprises, a user device, the user device can comprise, but is not limited to, for example a GPS receiver, a camera, and a computer system, the computer system further comprising: at least one processor, a graphical user interface; and a computer-usable medium embodying computer program code, the computer-usable medium capable of communicating with at least one processor, the computer program code comprising instructions executable by at least one processor and configured for: receiving data associate with the loss site, and generating inspection data from the loss site, comprising data representing an inventory of at least a portion of articles present at the loss site.

In an embodiment, each classification includes an estimated total volume occupied by the article during transportation and/or storage, and wherein the restoration cost for the loss site is based at least partially on a total volume occupied by the articles. In an embodiment, the classification comprises an estimated restoration cost of the article, based on predetermined values.

In an embodiment, the inspection data further comprises a type of loss, and wherein the estimated restoration cost of the article is partially based on the type of loss. In an embodiment, the inspection data further comprises a geographic location of the loss site, and wherein the estimated restoration cost can be partially based on the geographic location of the loss site.

In an embodiment, each of the articles identified in the inventory includes a relative location of the article at the loss site, and wherein the estimated restoration cost can be partially based on the relative location of each of the articles at the loss site.

In an embodiment, the system further comprises obtaining a total area of each of the relative locations present at the loss site, and wherein the estimated restoration cost can be partially based on the total area of the relative locations present at the loss site.

In an embodiment, the relative location of the article at the loss site includes an elevation of the location of the article relative to a ground level, a distance from the location of the article to an access point of the loss site, or a combination thereof.

In an embodiment, the classification of each of the plurality of articles comprises a base designation indicating a plurality of attributes of the article.

In another embodiment, a method of estimating a restoration cost of a loss site, comprises obtaining data representing an inventory of at least a portion of articles present at the loss site, determining from these data a classification for each of the plurality of articles identified in the inventory according to predetermined classification criteria, and generating an estimated restoration cost for the loss site based at least partially on the classifications of each of the plurality of articles.

In an embodiment of the method, each classification includes at least one of an estimated total volume occupied by the article during transportation and/or storage, and wherein the restoration cost for the loss site is based at least partially on a total volume occupied by the articles and an estimated restoration cost of the articles, based on predetermined values.

In an embodiment of the method, the inspection data further comprises at least one of a type of loss, wherein the estimated restoration cost of the article can be partially based on the type of loss, or possibly a location of the loss site, wherein the estimated restoration cost is at least partially based on the geographic location of the loss site, and a relative location of the article at the loss site, wherein the estimated restoration cost is at least partially based on the relative location of each of the articles at the loss site.

In an embodiment, the method may further comprise obtaining a total area of each of the relative locations present at the loss site, and wherein the estimated restoration cost can be at least partially based on the total area of the relative locations present at the loss site.

In an embodiment, the classification of each of the plurality of articles comprises a base designation indicating a plurality of attributes of the article, wherein the base designation comprises at least one of: a plurality of predetermined indicating sets of text characters, numeric characters, or a combination thereof, arranged in a particular order wherein both the content of the set and a location of the set within the base designation are indicative of the attributes of the article according to predetermined criteria plurality of pre, determined indicating sets, each comprising characters or numbers, arranged sequentially to represent at least a group, a class, a type, and/or a style of the article according to predetermined criteria, and a plurality of predetermined indicating sets, each comprising one or more numeric characters arranged sequentially to represent specific attributes of the article according to predetermined criteria.

In an embodiment, the classification further comprises one or more additional attribute sets and/or fields that may be appended to the base designation, wherein the content of the attribute sets represent features of the article in addition to those indicated by the base designation according to predetermined criteria and wherein the attribute sets may indicate a relative size of the article, a level of complexity of the article, a level of contamination present on the article, a material from which the article is constructed, a shape of the article, or a combination thereof, for example.

In certain embodiments, the systems and methods can include the generation of a comparative bid where no on-site visit is completed. In such embodiments, the estimate can be based on data, photos, video, voice recording, transcription and combinations thereof, provided from the loss site.

In an embodiment, the data representing an inventory of at least a portion of articles present at a loss site can include data and photos gathered during an on-site inspection conducted by an inspector present at the loss site utilizing a computerized inspection system configured to present a series of questions to the inspector, and to receive a corresponding series of answers from the inspector, to provide the inventory of at least a portion of articles present at the loss site.

In another embodiment, the method can include the use of an application remotely, without direct access to the loss site. In such an embodiment, the app can be used to provide questions which can be answered based solely on photographs and other data collected at a different time and/or by a different person.

In an embodiment of the method the computerized inspection system presents the series of questions to the inspector and receives the answers from the inspector via a graphical user interface comprising, for example, a plurality of menus, drop down selections, buttons, data entry fields, barcode entry fields, photographic image and video entry fields, freehand drawing fields, verbal recording and/or translation, or a combination thereof.

In an embodiment, the method further comprise a review step, wherein one or more data utilized to generate the estimated restoration cost for the loss site may be revised, and another estimated restoration cost for the loss site generated based on the revised data; and saving any portion of the data utilized to generate the estimated restoration cost for the loss site in an electronic database.

In another embodiment, a system comprises a computer system, the computer system further comprising: at least one processor; a graphical user interface; and a computer-usable medium embodying computer program code, the computer-usable medium capable of communicating with the at least one processor, the computer program code comprising instructions executable by the at least one processor and configured for: receiving inspection data from a loss site, comprising data representing an inventory of at least a portion of articles present at the loss site, determining from these data a classification for each of the plurality of articles identified in the inventory according to predetermined classification criteria, generating an estimated restoration cost for the loss site based at least partially on the classifications of each of the plurality of articles; and generating an estimated restoration cost of the article, based on predetermined values.

### BRIEF DESCRIPTION OF THE FIGURES

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

FIG. 1 depicts a block diagram of a computer system which is implemented in accordance with the disclosed embodiments;

FIG. 2 depicts a graphical representation of a network of data-processing devices in which aspects of the present embodiments may be implemented;

FIG. 3 depicts a computer software system for directing the operation of the data-processing system depicted in FIG. 1, in accordance with an example embodiment;

FIG. 4 depicts a block diagram of a system for loss evaluation and restoration cost of a loss site, in accordance with the disclosed embodiments;

FIG. 5 depicts a block diagram of a loss estimate module, in accordance with the disclosed embodiments;

FIG. 6A depicts a block diagram of a user portal, in accordance with disclosed embodiments;

FIG. 6B depicts a block diagram of a user app, in accordance with disclosed embodiments;

FIG. 7 depicts a flow chart of steps associated with generating a loss site estimate, in accordance with the disclosed embodiments;

FIG. 8A depicts a new dispatch interface, in accordance with the disclosed embodiments;

FIG. 8B depicts a scheduling interface, in accordance with the disclosed embodiments;

FIG. 8C depicts a contents estimating interface, in accordance with the disclosed embodiments;

FIG. 8D depicts a supplemental loss site sheet, in accordance with the disclosed embodiments; and

FIGS. 9A-9AU depict aspects of a user interface associated with a loss estimate application, in accordance with the disclosed embodiments.

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter, with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Terms such as “first”, “second”, and the like used herein may refer to various elements of various embodiments of the present disclosure, but do not limit the elements. For example, such terms are used only to distinguish an element from another element and do not limit the order and/or priority of the elements. For example, a first user device and a second user device may represent different user devices irrespective of sequence or importance. For example, without departing from the scope of the present disclosure, a first element may be referred to as a second element, and similarly, a second element may be referred to as a first element.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope and concept of the invention as defined by the appended claims.

It should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a physical range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

The following definitions are provided in order to aid those skilled in the art in understanding the detailed description.

As used in the specification and claims, “near” is inclusive of “at”.

A loss site refers to any real property, or portion of real property that has been damaged. Typical loss sites may include rooms within a dwelling or the entire dwelling or structure. Losses may occur from any type of loss or combination of types of losses. Typical types of losses include, but are not limited to fire, flooding, earthquake, mudslide, infestation, and/or any natural or manmade condition that renders the loss site in need of repair or unsuitable for an intended purpose. Embodiments disclosed herein can relate to any loss site, including but not limited to, residential properly, commercial property, industrial property, storage facilities, and the like. For example, water damage is possible when a fire is extinguished. All such losses can be accounted for according to the embodiments here.

For purposes herein “articles” identified at a loss site may include any chattel, object, fixture, thing, or group of things present at the loss site.

Each loss site is considered to have a geographic location, e.g., and position on the planet Earth, but may also include a relative location, which is relative to a particular point present at the geographic location. For example, a loss site may include a dwelling located at 100 Main Street, Small Town USA. This loss site may further include any number of loss sites such as, for example, an upper bedroom of the dwelling where damage occurred. The “upper” bedroom being relative to a ground floor of the dwelling and “bedroom” characterizing the intended purpose of this room, as opposed to a kitchen, bathroom, or exercise room. The relative location of a loss site, in this instance an upper bedroom, may also indicate a distance from a point of access to the loss site, e.g., a front door of the dwelling, and a set of stairs that must be traversed to arrive at the loss site.

As is known to the experienced inspector, each journey from an access point to the loss site, e.g., the journey from a driveway proximate to a front door of a dwelling where a transport vehicle is parked, up a staircase, down a hall and into the upper bedroom, represents a measure of time required to conduct the restoration. As such, the relative location of the loss site may affect the cost of restoration. For example, the convenience of parking vehicles may affect the cost of restoration. If vehicles cannot be parked proximate to the loss site (e.g., there is no driveway) The distance from the point of access may affect the cost of restoration. Likewise, if no driveway is available and vehicles need to be periodically moved, this will also affect the cost of restoration.

Likewise, the total area of the loss site and/or the relative location may affect the total cost of restoration. As such, the total area of a loss site may include the total square footage available within a dwelling, and/or the total square footage of a particular room within the dwelling. In addition, the intended purpose of the loss site may be of consequence in determining the total cost of restoration. For example, the packing, storing, cleaning, and transporting of contents often associated with a bedroom of a particular size may be different than those of an exercise room or kitchen of the same or different size. Likewise, the amount of materials typically present in a room often depend on the size or square footage of the room, which may also be relevant to determining a partial or total cost of restoration of a loss site. Types of contents, density of the contents in the space, and condition of the contents all play a role in the loss, and the potential associated expense.

For purposes herein, an inspector is any person physically present at a loss site, or who has visual access to the loss site, e.g., a person remotely controlling a remote vehicle present at a loss site, or a person able to review data collected from a loss site.

It will be understood that when an element (for example, a first element) is referred to as being operatively or communicatively “coupled with/to” or “connected to” another element (for example, a second element), it can be directly coupled with/to or connected to the other element or an intervening element (for example, a third element) may be present.

As used herein, the expressions “configured to”, “capable of”, “dimensioned to” and the like, used herein may be used interchangeably with, for example, the expression “suitable for”, “having the capacity to”, “designed to”, “adapted to”, “made to”, or “capable of”. The term “configured to (or set to)” does not mean only “specifically designed to” in hardware.

Within the present disclosure, the word “exemplary” and/or “preferably” are used to mean “serving as an example, instance, or illustration.” Any implementation or aspect described herein as “exemplary” and/or “preferably” is not necessarily to be construed as preferred or advantageous over other aspects of the disclosure in an overall limiting sense, but only in relation to specific embodiments. Likewise, the term “aspects” does not require that all aspects of the disclosure include the discussed feature, advantage, or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object.

The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The terms used herein are used to describe specific embodiments of the present disclosure and are not intended to limit the scope of the present disclosure. The terms of a singular form may include plural forms unless otherwise specified. Unless otherwise defined herein, all the terms used herein, which include technical or scientific terms, may have the same meaning as that generally understood by a person skilled in the art to which the present disclosure pertains. It will be further understood that terms, which are defined in a dictionary and commonly used, should also be interpreted as is customary in the relevant related art and not in an idealized or overly formal manner unless expressly so defined herein. In some cases, even if terms are defined in the specification, they may not be interpreted to exclude embodiments of the present disclosure.

In various embodiments of the present disclosure, the components referred to in embodiments of the device is not limited to currently known devices but may include new devices suitable for the intended purpose which are subsequently produced due to the development of new technologies.

As used herein, the terms “generating”, “determining” and “conversion” encompasses a wide variety of actions. For example, “determining” may include calculating, computing, processing, deriving, investigating, looking up (e.g., looking up in a table, a database, or another data structure), ascertaining and the like. Also, “determining” may include receiving (e.g., receiving information), accessing (e.g., accessing data in a memory) and the like. Furthermore, “determining” may include resolving, selecting, choosing, establishing and the like. Likewise, “controlling” encompasses a wide variety of actions, the totality of which results in the functioning of the device for the intended purpose.

The expression “a device configured to” may mean that the device is “capable of” operating together with another device or other components. For example, an “electronic memory assembly” configured to (or set to) store data for subsequent retrieval, refers to any such memory module or modules, with the associated circuitry, power source, and programming which render it capable of performing the corresponding operation of storage and retrieval utilizing a generic-purpose processor (e.g., a central processing unit (CPU) or an application processor) which may perform corresponding operations by executing one or more software programs which are stored on the memory device.

The various illustrative blocks, modules, flow conduits, and electrical circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

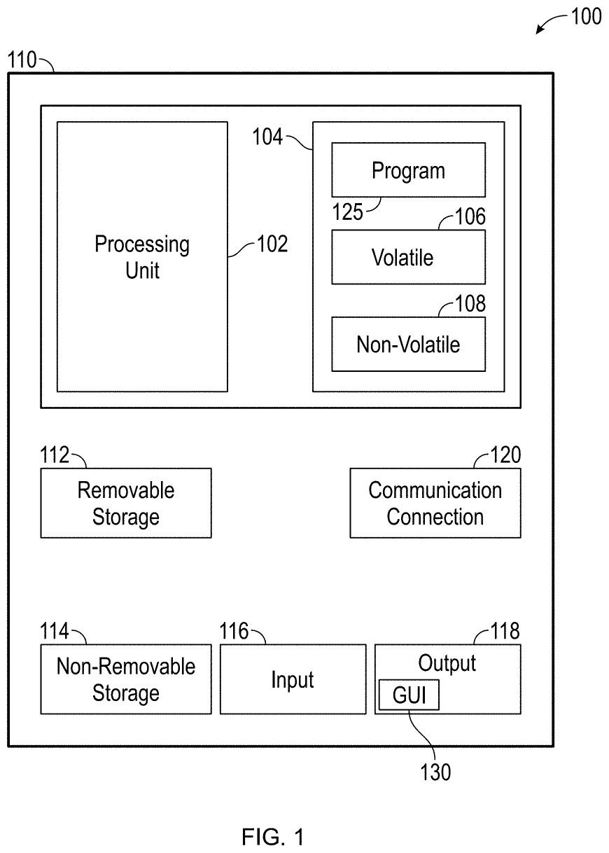

FIGS. 1-3 are provided as exemplary diagrams of data-processing environments in which embodiments of the present invention may be implemented. It should be appreciated that FIGS. 1-3 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

A block diagram of a computer system 100 that executes programming for implementing parts of the methods and systems disclosed herein is shown in FIG. 1. A computing device in the form of a computer 110 configured to interface with sensors, peripheral devices, and other elements disclosed herein may include one or more processing units 102, memory 104, removable storage 112, and non-removable storage 114. Memory 104 may include volatile memory 106 and non-volatile memory 108. Computer 110 may include or have access to a computing environment that includes a variety of transitory and non-transitory computer-readable media such as volatile memory 106 and non-volatile memory 108, removable storage 112 and non-removable storage 114. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions as well as data including image data.

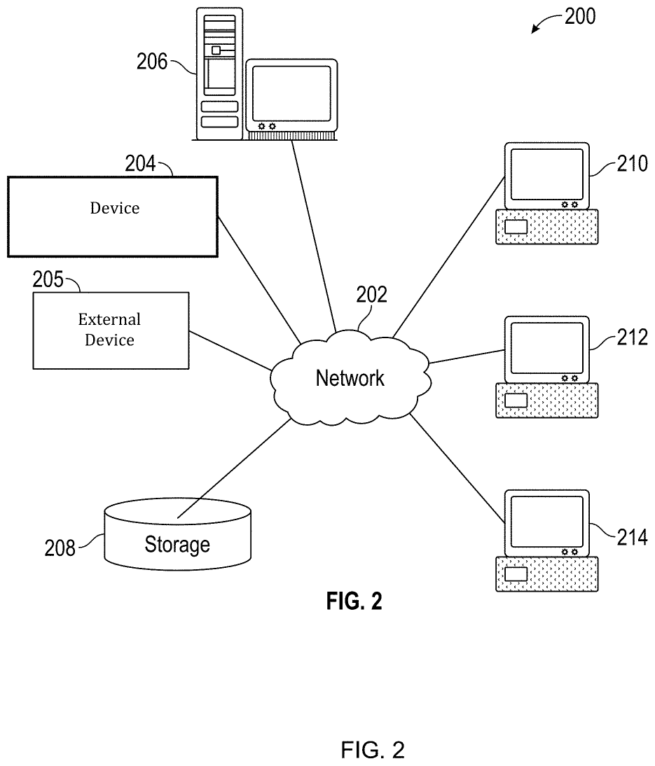

Computer 110 may include or have access to a computing environment that includes input 116, output 118, and a communication connection 120. The computer may operate in a networked environment using a communication connection 120 to connect to one or more remote computers, remote sensors, detection devices, hand-held devices, multi-function devices (MFDs), mobile devices, tablet devices, mobile phones, Smartphones, or other such devices. The remote computer may also include a personal computer (PC), server, router, network PC, RFID enabled device, a peer device or other common network node, or the like. The communication connection may include a Local Area Network (LAN), a Wide Area Network (WAN), Bluetooth connection, or other networks. This functionality is described more fully in the description associated with FIG. 2 below.

Input 116 can comprise a keyboard, touch screen, scanning device, photo input, RFID, voice recording device, voice translation device, image recognition system, sketch pad, mouse, touch pad, foot switch, or other such devices.

Output 118 is most commonly provided as a computer monitor, but may include any output device. Output 118 and/or input 116 may include a data collection apparatus associated with computer system 100. In addition, input 116, which commonly includes a computer keyboard and/or pointing device such as a computer mouse, computer track pad, or the like, allows a user to select and instruct computer system 100. A user interface can be provided using output 118 and input 116. Output 118 may function as a display for displaying data and information for a user, and for interactively displaying a graphical user interface (GUI) 130.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device 116 such as, for example, a pointing device such as a mouse and/or with a keyboard. A particular item can function in the same manner to the user in all applications because the GUI provides standard software routines (e.g., module 125) to handle these elements and report the user's actions. The GUI can further be used to display the electronic service image frames as discussed below.

Computer-readable instructions, for example, program module or node 125, which can be representative of other modules or nodes described herein, are stored on a computer-readable medium and are executable by the processing unit 102 of computer 110. Program module or node 125 may include a computer application. A hard drive, CD-ROM, RAM, Flash Memory, and a USB drive are just some examples of articles including a computer-readable medium.

FIG. 2 depicts a graphical representation of a network of data-processing systems 200 in which aspects of the present invention may be implemented. Network data-processing system 200 is a network of computers or other such devices such as mobile phones, smartphones, sensors, detection devices, and the like in which embodiments of the present invention may be implemented. Note that the system 200 can be implemented in the context of a software module such as program module 125. The system 200 includes a network 202 in communication with one or more clients 210, 212, and 214, and external device 205. Network 202 may also be in communication with one or more RFID and/or GPS enabled devices or sensors 204, servers 206, and storage 208. Network 202 is a medium that can be used to provide communications links between various devices and computers connected together within a networked data processing system such as computer system 100. Network 202 may include connections such as wired communication links, wireless communication links of various types, fiber optic cables, quantum, or quantum encryption, or quantum teleportation networks, etc. Network 202 can communicate with one or more servers 206, one or more external devices such as RFID and/or GPS enabled device 204, and a memory storage unit such as, for example, memory or database 208. It should be understood that RFID and/or GPS enabled device 204 may be embodied as a mobile device, cell phone, tablet device, monitoring device, detector device, sensor microcontroller, controller, receiver, transceiver, or other such device.

In the depicted example, RFID and/or GPS enabled device 204, server 206, and clients 210, 212, and 214 connect to network 202 along with storage unit 208. Clients 210, 212, and 214 may be, for example, personal computers or network computers, handheld devices, mobile devices, tablet devices, smartphones, personal digital assistants, microcontrollers, recording devices, MFDs, etc. Computer system 100 depicted in FIG. 1 can be, for example, a client such as client 210 and/or 212.

Computer system 100 can also be implemented as a server such as server 206, depending upon design considerations. In the depicted example, server 206 provides data such as boot files, operating system images, applications, and application updates to clients 210, 212, and/or 214. Clients 210, 212, and 214 and RFID and/or GPS enabled device 204 are clients to server 206 in this example. Network data-processing system 200 may include additional servers, clients, and other devices not shown. Specifically, clients may connect to any member of a network of servers, which provide equivalent content.

In the depicted example, network data-processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 200 may also be implemented as a number of different types of networks such as, for example, an intranet, a local area network (LAN), or a wide area network (WAN). FIGS. 1 and 2 are intended as examples and not as architectural limitations for different embodiments of the present invention.

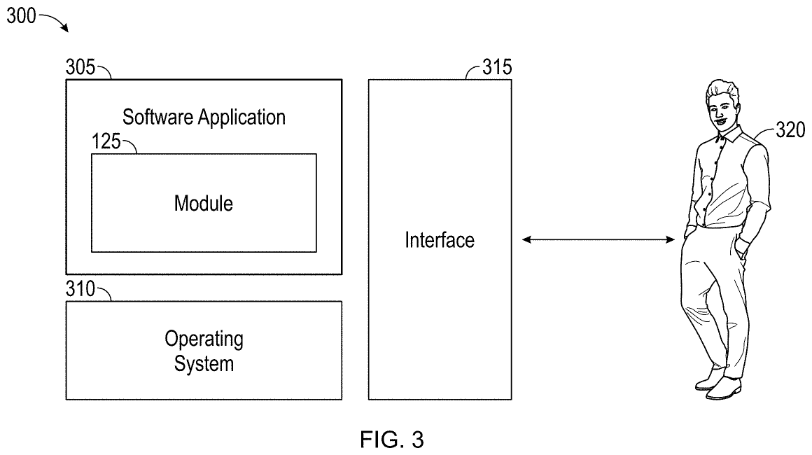

FIG. 3 illustrates a software system 300, which may be employed for directing the operation of the data-processing systems such as computer system 100 depicted in FIG. 1. Software application 305, may be stored in memory 104, on removable storage 112, or on non-removable storage 114 shown in FIG. 1, and generally includes and/or is associated with a kernel or operating system 310 and a shell or interface 315. One or more application programs, such as module(s) or node(s) 125, may be “loaded” (i.e., transferred from removable storage 114 into the memory 104) for execution by the data-processing system 100. The data-processing system 100 can receive user commands and data through user interface 315, which can include input 116 and output 118, accessible by a user 320. These inputs may then be acted upon by the computer system 100 in accordance with instructions from operating system 310 and/or software application 305 and any software module(s) 125 thereof.

Generally, program modules (e.g., module 125) can include, but are not limited to, routines, subroutines, software applications, programs, objects, components, data structures, etc., that perform particular tasks or implement particular abstract data types and instructions. Moreover, those skilled in the art will appreciate that elements of the disclosed methods and systems may be practiced with other computer system configurations such as, for example, hand-held devices, mobile phones, smart phones, tablet devices, multi-processor systems, printers, copiers, fax machines, multi-function devices, data networks, microprocessor-based or programmable consumer electronics, networked personal computers, minicomputers, mainframe computers, servers, medical equipment, medical devices, and the like.

Note that the term module or node as utilized herein may refer to a collection of routines and data structures that perform a particular task or implements a particular abstract data type. Modules may be composed of two parts: an interface, which lists the constants, data types, variables, and routines that can be accessed by other modules or routines; and an implementation, which is typically private (accessible only to that module), and which includes source code that actually implements the routines in the module. The term module may also simply refer to an application such as a computer program designed to assist in the performance of a specific task such as word processing, accounting, inventory management, etc., or a hardware component designed to equivalently assist in the performance of a task.

The interface 315 (e.g., a graphical user interface 130) can serve to display results, whereupon a user 320 may supply additional inputs or terminate a particular session. In some embodiments, operating system 310 and GUI 130 can be implemented in the context of a “windows” system. It can be appreciated, of course, that other types of systems are possible. For example, rather than a traditional “windows” system, other operation systems such as, for example, a real time operating system (RTOS) more commonly employed in wireless systems may also be employed with respect to operating system 310 and interface 315. The software application 305 can include, for example, module(s) 125, which can include instructions for carrying out steps or logical operations such as those shown and described herein.

The following description is presented with respect to embodiments of the present invention, which can be embodied in the context of, or require the use of a data-processing system such as computer system 100, in conjunction with program module 125, and data-processing system 200 and network 202 depicted in FIGS. 1-3. The present invention, however, is not limited to any particular application or any particular environment. Instead, those skilled in the art will find that the systems and methods of the present invention may be advantageously applied to a variety of system and application software including database management systems, word processors, and the like. Moreover, the present invention may be embodied on a variety of different platforms including Windows, Macintosh, UNIX, LINUX, Android, Arduino and the like. Therefore, the descriptions of the exemplary embodiments, which follow, are for purposes of illustration and not considered a limitation.

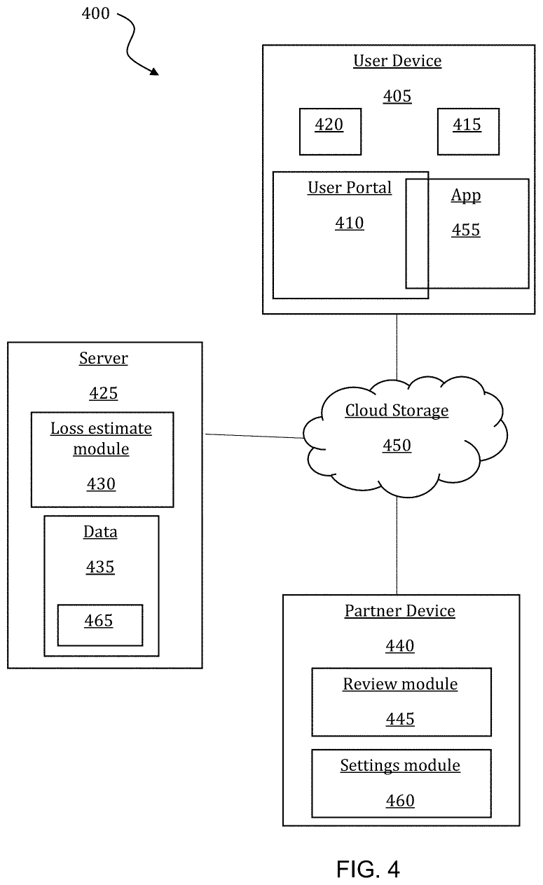

FIG. 4 illustrates a block diagram of a system 400 for collecting information at a loss site and generating a loss estimate. The system can generally include a mobile device, or user device 405 that provides a user portal 410. The user portal 410 can serve as the interface through which the inspector (or user) interacts with the system 400.

As illustrated in FIG. 4, the user device 400 can be any device that is equipped with a camera 415, and may also have a GPS receiver 420, such that the device 405 can verify position and take photographs. In certain embodiments, the user device 405 can comprise a mobile device, smart phone, tablet device, computer, smart watch, or other such device.

The user device 405 can be equipped with a user portal 410. In certain cases, the user portal 410 can comprise a standalone software module (e.g., an app). In other embodiments, the user portal 410 can be a web portal. The user portal 410 serves as the interface through which the user interacts with the system 400. The interface can comprise a specially designed graphical user interface that allows the user to receive alerts relating to the loss site, instructions, dangers, etc., and to collect information and photographs related to the loss site. This can be achieved in a number of ways as further detailed herein.

The mobile device 405 can interact with other aspects of the system through a wired or wireless connection via the world wide web. In certain embodiments, this can be achieved using a cloud computing architecture. In certain embodiments, a server 425 can provide data 435 storage and can provide a loss estimate module 430. The loss estimate module 430 can accept data from the site inspection, and generate site reports, sheet 1, and other documents as further detailed herein. The data can further comprise a list 465 comprising chargeable activities and/or chargeable articles associated with restoration at the loss site. It should be appreciated that, in other embodiments, the loss estimate module 430 can be installed on the partner device 440 or the user device 405. Indeed, the architecture illustrated in FIG. 4 is exemplary and other arrangements are possible.

The system 400 further includes a partner device 440. The partner device 440 can comprise a mobile device or smart phone, a tablet device, a computer, a smart watch, or other such device. The partner device 440 can be equipped with a partner portal 445. The partner portal 445 serves as the interface through which the partner interacts with the system 400. An interface associated with the partner portal 445 can comprise a specially designed graphical user interface that allows the partner to set and receive alerts relating to scheduling, monitor actions at a loss site, send messages to a user, and monitor loss site metrics or other data. It should be understood that the partner device 440 can comprise multiple devices accessible by multiple partners. Such access can be limited with security features as further detailed herein.

The loss estimate module 430 can comprise the root application or applications (e.g., software) that is used to control the system 400. The server 425 can serve data to, and accept data from, the user device 405 and partner device 440. In other embodiments, cloud storage 450 can be used to store some or all of the relevant data and/or software associated with the system 400.

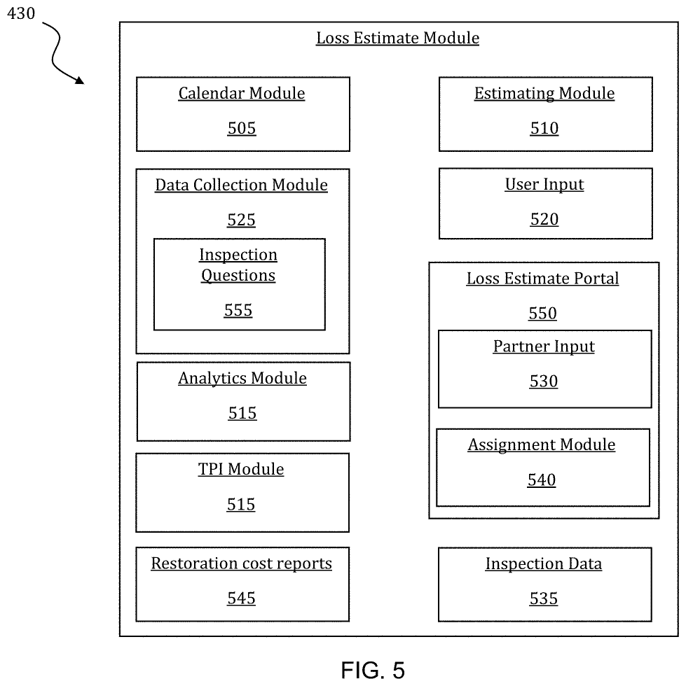

FIG. 5 illustrates a system diagram of the loss estimate module 430. The loss estimate module 430 can include a calendar module 505. The calendar module 505 can be connected to a partner input 530 associated with the partner device 440. Note this input can comprise a hardwired or wireless communications connection.

The calendar module 505 can be used to set various appointments for the user (e.g., the inspector). In an exemplary embodiment, the calendar module 505 can be accessed by the partner device 440. The partner can schedule various loss estimate appointments in a calendar associated with the calendar module 505. Such appointments can be, for example, an initial interview date, or loss estimate walkthrough of a loss site to collect loss estimate data. The calendar module 505 can include data fields in a structured database indicative of the type of appointment, the time of the appointment, and the location of the appointment.

In certain embodiments, the loss estimate module 430 can use the location of the appointment to create a geotag indicative of a real world location associated with the location of the appointment. The partner can set the parameters of the appointment. For example, the geotag can be a set size or location. Modifications to the calendar can be made by the partner on the partner device 440, or the user on the user device 405, and can update the calendar provided via the user portal 410.

The loss estimate module 430 can further include an estimating module 510. As used herein, an estimate, quote or determination which is “based at least partially on” a particular thing, property and/or the like, refers to that thing, property and/or the like being considered and/or incorporated into the final output, but which is not necessarily the only or sole basis for the determination.

In embodiments the estimating module 510 can implement a method of estimating a restoration cost of a loss site. The estimating module can include various subroutines, files, scripts, and or programming, as further detailed herein. This can include the steps of generating or receiving, data with a data collection module 525 and/or user input 520. The data can comprise data representing an inventory of at least a portion of articles present at the loss site; determining from these data a classification for each of the plurality of articles identified in the inventory according to predetermined classification criteria; and generating a list comprising chargeable activities and/or chargeable articles associated with restoration at the loss site, and/or generating an estimated site restoration cost for the loss site based at least partially on the classifications of each of the plurality of articles.

In some embodiments, each classification of an article includes an estimated total volume (physical space) occupied by the article in situ, or during transportation and/or storage. For example, this may include the space the article occupies when “packed” in a storage or transport box as required to transport the item for off-site cleaning. Accordingly, the total volume (physical space) occupied by a chair required for transportation and/or storage of the article may often be larger than the absolute physical space or volume the chair occupies due to the shape of the item and the ability to pack the item within an enclosure, e.g., a box, whereas a volume of dinner plates required for transportation and/or storage of the articles may often be nearer to the absolute physical space or volume the plates occupy due to the shape of the items and the ability to pack them more tightly within an enclosure. In embodiments, the site restoration cost for the loss site is based at least partially on a total volume occupied by the articles.

It should be appreciated that the volume is one metric which can be used for loss estimation. In other embodiments, other metrics can be used, individually, or in combination with other metrics. Such metrics include, but are not limited to, conversions such as, cubic feet to cubic inches, cubic feet to gallons, cubic feet to cubic yards, cubic feet to liters, cubic inches to cubic feet, square inches to square feet, square inches to gallons, square meters to square feet, square yards to inches, square inches to square centimeters, linear feet to cubic inches, linear feet to square feet, and linear feet to square yards. Loss estimation metrics can further comprise measures of volume, area, weight, mass, density, or other such metrics.

In embodiments, the classification of each article may include an estimated restoration cost of the article, based on predetermined values, calculated with the analytics module 515. Examples of restoration costs include cleaning costs of an item, which may be a flat rate based on the type of item, and/or a cumulative labor, handling, and/or supply cost. The restoration cost may also be dependent on the type of loss, and/or extent of damage or soiling of the item. For example, a restoration cost of an article of clothing may depend on the materials from which the article is made, the type of construction, the extent of soiling, the distance the article must be transported for cleaning, any expertise required for the particular article, the price of such cleaning in the market or physical location of the article, e.g., the cost of cleaning in Manhattan, N.Y. vs. El Paso, Tex., and/or the like.

Accordingly, in embodiments, the inspection data 535 further comprises a type of loss, and the estimated restoration cost of the article which is partially based on the type of loss, and/or the inspection data may further comprise a geographic location of the loss site and the estimated site restoration cost is at least partially based on the geographic location of the loss site.

In some embodiments, each of the articles identified in the inventory includes a relative location of the article at the loss site (e.g., located in an upper bedroom or a basement), and the estimated partial or total site restoration cost is at least partially based on the relative location of each of the articles at the loss site, e.g., an article located on the 7th floor of an apartment building wherein the closest parking spot accessible to a moving truck needed to transport the articles is located 400 yards from the front door of the building, requiring a particular amount of time per journey to and from the loss site. Accordingly, in embodiments, the relative location of the article at the loss site includes an elevation of the location of the article relative to a ground level (e.g., a floor level), a distance from the location of the article to an access point of the loss site (e.g., a loading zone, access door, or the like), or a combination thereof.

In embodiments, the method may further comprise obtaining a total area of each of the relative locations present at the loss site, wherein the estimated site restoration cost is at least partially based on the total area of the relative locations present at the loss site. In addition, the total area of the relative location may serve as a verification metric to assess the accuracy of a particular quote, based at least in part on a predetermined average of articles typically included in a room having a particular use. This can also be a component used in estimating the cost of an in situ general wipe down.

In embodiments, the classification assigned to each of the plurality of articles identified in the inventory comprises a base designation indicating a plurality of attributes of the article. In some embodiments, this base designation comprises a plurality of predetermined indicating sets or fields, which may be alpha-numeric, e.g., text characters, numeric characters, or a combination thereof. Each of these fields are arranged in a particular order wherein both the content of the set e.g., the two or three character code, and a location of the set e.g., field 1, field 2 . . . within the base designation are indicative of the attributes of the article according to predetermined criteria.

For example, an article identified by the inspector may be a dining room chair. In this example, the base designation comprises four different fields: a group, which in this this case would be furniture, a class, which in this case could be chair, a type, which in this case could be hard, as opposed to upholstered, and a style, which in this case could be dining. If each of the sets or fields is represented by a three letter code, the brief descriptive base designation of this article could be “FurChaHarDin”, wherein these three letter codes are selected from a predetermined list. Similarly, a numeric code can be applied with a 2-digit code can be used for group, class, type, and style resulting in a numeric base code such as 11020101.

Accordingly, in embodiments, the base designation comprises a plurality of predetermined indicating sets, each comprising the same number of characters, arranged sequentially to represent at least a group, a class, a type, and/or a style of the article according to predetermined criteria. In some of such embodiments, the base designation comprises a plurality of predetermined indicating sets, each comprising two or more numeric characters arranged sequentially to represent specific attributes of the article according to predetermined criteria.

However, it will be appreciated that all dining chairs are not created the same, do not have the same overall size, and do not occupy the same volume when packed for storage or transportation. Furthermore, all dining chairs are not soiled and/or contaminated to the same degree and thus each may require a different amount and/or type of cleaning depending on materials of construction and/or level of contamination at a particular loss site. To address such issues, embodiments according to the instant disclosure may utilize a classification system that further comprises one or more additional attribute sets and/or fields appended to the base code, wherein the content of the attribute sets represent features of the article in addition to those indicated by the base code according to predetermined criteria. Another embodiment can comprise a delimiter to separate the base code components. For example, a delimiter such as a comma can be used. A delimiter would not require the components to be of fixed length.

For example, using the above dining chair, this particular article may be oversized relative to some standard dining chair embodied in the base code as numeric code 11020101 or with a base designation of FurChaHarDin. In embodiments, the additional attribute codes may be selected from predetermined lists, e.g., large, vintage, and/or any number of predetermined criteria. In embodiments, one or more of these attributes may be appended to the base designation. In the present example, an oversized vintage dining chair may have the appended base designation of FurChaHarDinLgVn. The base code can be extended with a single letter and 2 digit code signifying the attribute. For example, “S25” can represent the size “large”. Likewise, vintage can be represented with V22, thus resulting in a full code of 110201015V22.

Accordingly, in embodiments, the attribute sets indicate a relative size of the article, a level of complexity of the article (e.g. a lining of a coat), a gender of the article (e.g., a man's shirt or a woman's dress), the material of construction (e.g. wool), the finish on the surface (e.g. metallic), embellishments (e.g., inlayed ivory table, a beaded dress), a size, a vintage, a style, an estimated worth, an overall condition, a level of contamination present on the article (e.g., a cleaning level required), a shape of the article, an age (e.g., antique), any unique attribute present in or on the article, or any combination thereof. It should be appreciated that the attributes may affect the volume used and/or other parameters in the method of determining the estimate.

In embodiments, the base characterization of the articles may connote and/or be associated with a particular volume the article occupies during storage and/or transportation, a cost to clean depending on the level of contamination, and/or the market value of that service, a time to pack for storage, a time to move articles into the transportation vehicle, and/or transportation to and from an off-site cleaning facility, any ancillary packing materials that may be required, e.g., overwrap, blankets, and the like, as well as a time required to physically pack and remove the article (labor costs), as well as other factors needed to determine a restoration cost. In embodiments, the method is configured such that any attributes associated with the base designation may add or subtract e.g., by a percentage, fixed amount, or some other calculation, to this previously established value. Using the above example, suppose for a particular instance, in view of the type of damage, the amount of damage, the location of the dining chair, and the like, the method assigns a restoration cost of this dining chair to be $10.00. Further in this example it has been predetermined that an oversized article typically requires an increase of 20% over what a normal sized article requires due to the increased surface area, and a vintage article typically requires an increase of 30% over what a non-vintage article requires due to the additional delicacy required in the cleaning effort. In this example, the restoration cost of the oversized vintage dining chair would be calculated by the method to be $15.00, representing 50% of the base cost ($5.00) added to the base cost of $10.00. Note, the volume would only be affected by the size attribute which may differ from the percentage increase to the cost. The size can also affect a cleaning cost.

In embodiments, the characterization of each article may thus represent an expense, and the estimated cost of restoration may be based at least partially on the total of each of the articles in need of restoration.

In embodiments, the inspection report of the loss site may be provided. However, in another embodiment, the inspection data and inspection report are at least partially generated during an on-site inspection conducted by an inspector present at the loss site utilizing a computerized inspection system 400 configured to present a series of questions or prompts to the inspector, and to receive a corresponding series of answers from the inspector, to provide the inventory of at least a portion of articles present at the loss site. The inspector may also provide data indicative of area, or volume at the loss site. This can be realized with the data collection module 525 which can include the questions to present to the inspector, as well as templates for collecting requisite images or other data.

In embodiments, the computerized inspection system 400 is configured to present the inspector with a series of questions 555 and to receive the answers from the inspector on a user device 405. In embodiments, the questions 555 are presented from the loss estimate module 430 and answers received via a graphical user interface on the user portal 410, which can include a plurality of menus, drop down selections, buttons, data entry fields, barcode entry fields, photographic image entry fields, freehand drawing fields, or a combination thereof. The user device can further include a GPS module 420 and camera 425 configured to allow data to be uploaded on the user portal 410 and provided to the loss estimate module 430.

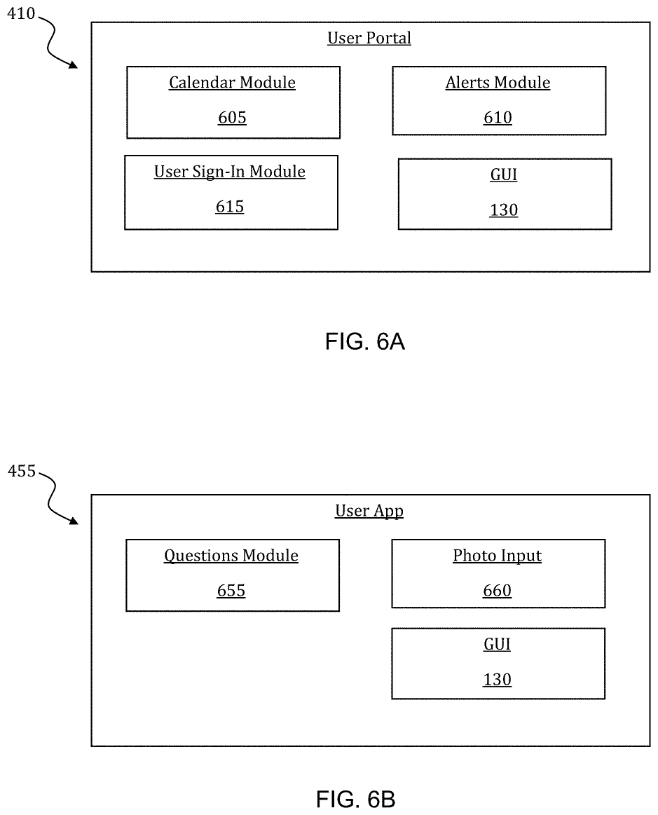

The user portal 410 serves as the interface through which the user interacts with the system 400 and is further illustrated in FIG. 6A. The user portal 410 can be embodied as specially designed software that is executed by a mobile device or other computer system such as computer system 100. The user portal 410 can include a user interface embodied as a graphical user interface, such as GUI 130. The user portal 410 allows the user to interact with the calendar module 605. The interface 130 can display upcoming appointments. The user interface can inform the user of the type, time, and place of the appointment.

An alerts module 610 can be used to alert the user to upcoming appointments. The alerts module 610 can send push notifications, or other such notification to alert a user that an appointment is upcoming, or that the appointment has been missed. The alerts module 610 can similarly send an alert to the partner when an appointment is missed. The alerts module 610 can notify the user when an inspection report is complete or after the inspection data has been transmitted, if further information is required.

The user portal can further include a user sign-in module 615. The user sign-in module allows the system 400 to verify the user is the designated service provider attempting to collect data about a loss site. The user sign-in module 615 can be used to verify that the user has attended an appointment.

As noted above, the ability to accurately and precisely identify each and every item in need of restoration is paramount to determining an accurate and defensible estimate. To allow less experienced inspectors to adequately obtain an inventory, in embodiments, one or more of the series of questions presented to the inspector are based on one or more answers previously received from the inspector. For example, the inspector may indicate the presence of articles classified as furniture. Based on this answer, the method may then be configured to request information about the class of furniture e.g., a dropdown list that includes a chair. Based on this answer, the method may be configured to present questions about the type of chair, e.g., hard or soft, and the style of the chair e.g., dining. In embodiments, the computerized inspection system may be further configured to present the inspector with a typical list of additional attributes that may be used to describe articles in general, or which may be further tailored to answers previously provided, e.g., oversized, vintage, and the like. In addition, the computerized inspection system can be configured with preselected lists of article types typically found in the room the inspector has identified.

Accordingly, in embodiments, the method is configured to determine the classification of each of the plurality of articles in the inventory according to predetermined classifications, and is at least partially based on the answers provided by the inspector to the series of questions presented to the inspector via the user device 405 (e.g., via an “Inspection App”) during the on-site inspection.

In certain embodiments, the computerized inspection system 400 comprises a system, e.g., an app or a program running on a tablet, a smartphone, and/or the like, which can be configured to operate autonomously on a handheld and/or portable computing device 405, which may continue to operate in the absence of a network and/or internet connection. In other embodiments, this same set of instructions could be embodied in a web-based system. However, the ability for at least a portion of the system to operate autonomously can be of particular importance during a natural disaster, wherein such infrastructure may not be available.

In embodiments, the system further comprises a review module 445 provided on a partner device 440, wherein one or more data utilized to generate the estimated site restoration cost for the loss site by the loss estimate module 430 may or may not be revised, and another estimated site restoration cost for the loss site generated based on the revised data. One or more review steps may be incorporated at any point within the disclosed methods.

In embodiments, the system can be configured for saving any portion of those data utilized to generate the estimated site restoration cost for the loss site in an electronic database. The database can be embodied as a spreadsheet, or other such data organization means. This allows for interfacing of the data with other systems, for other purposes, and the like, and to provide a record for future use. These data may also be utilized to further refine the various classifications and improve the accuracy of the estimate produced according to embodiments disclosed herein.

In embodiments, the system 400 and associated method can include an assignment module 540, wherein an assignment is instigated in any number of formats. For example, an insurance adjuster may request a service provider to inspect a loss site for the purpose of preparing an estimate of remediating a home and the contents within after a loss due to a fire, water, or other disaster. The assignment step may include collection of information necessary to enable a site visit and preparation of the estimate. Types of such information collected may include, but is not limited to, the insured's name, address, insurance company, adjuster name, contact information, specific instructions such as “do not include the basement”, and the like.

In embodiments, the assignment step provides a job coordinator or other administrator with a loss assignment or other dispatch comprising the necessary loss information to provide the portion of the computerized inspection system 400 with a list of prompted questions required by the method and the remaining portions of the computerized inspection system to provide an accurate instruction report and produce an estimate of a restoration cost. It should be appreciated that the restoration cost can comprise a total restoration cost, or partial restoration cost according to the specific circumstance.

The assignment module can interface with the calendar module 505 for scheduling. The method may further include an on-site inspection by the inspector, which may require determining a date & time for the on-site visit. The method may also include a dispatch step, wherein data may be pre-loaded into the loss estimate module 430 of the computerized inspection system 400, using the partner input 530, to enable the estimator to make the appropriate selections on the application. For example, if the loss is a fire loss and cleaning, restoration of artwork, antique furniture is needed, such questions or a question bank may be provided via the partner input to the loss estimate module 430. This can then be preloaded via the user portal 410 of the user device to allow operation of this portion of the system 400 in the absence of an internet connection. For example, if the loss was caused by water, obtaining a proper estimate will require the inspector to closely inspect the bottom of furniture for possible restoration, repair, or refinish and the like. As such, these questions can be pre-loaded. The loss estimate module 430 can further include a third party interface (TIP) module 560, which serves as an interface for third parties.

Likewise, the preset parameters provided by the dispatch step may allow for more accurate self-calculation, extra supervision labor hours, extra labor for moving with a long walking distance to the moving truck, e.g., when the loss is present in a large complex, among other issues that would only be considered by one with significant experience as an inspector. As such, the method according to embodiments disclosed herein allows many to benefit from the years of experience obtained by only a few.

While the dispatch step is not necessarily required, all the data can be loaded directly to the user device 405 via the user portal 410, utilizing the smart device facilitating subsequent data entry. Dispatch may be accomplished via a desktop computer, webpage, and/or the like, further easing the burden of entering the necessary data in the mobile device itself.

In embodiments, the dispatch step may be incorporated into a web portal arrangement to allow access essentially anywhere internet access is available. The dispatch may be either dispatched immediately or scheduled with the calendar module 505 to be sent at a later date/time.

As illustrated in FIG. 6B, in embodiments, the inspection and data collection portion of the computerized inspection system 400, can be referred to as the “Inspection App” 455, which can be configured to run on any number of mobile app platforms enabling extensive configuration options as well as further development as may be required for a specific purpose and/or user. The user app can include a questions module 655, photo input 660, as well as a GUI 130 for providing information to the user. The type of data that may be collected by the inspector may include photographs, drop down selection choices, radio button selection, freely typed and/or dictated entries, signatures, drawings, sketches, scanned barcodes, and the like.

A proper amount of information is required in order to calculate an accurate estimate of the cost for restoration. The inspection app 455 facilitates the inspector on site via pre-prompted questions to obtain this necessary information. The inspection app 455 guides the inspector during the inspection of each of the affected rooms (loss sites) and allows for entry of the articles present. These data are then utilized by the computerized inspection system 400 to determine the volume occupied by the articles for packing, shipping and storage, thus allowing for a determination of a number of boxes required to pack the articles, including items often overlooked such as the small decorations, figurines, and the like typically present in particular rooms. The inspector can be led via pop up tips provided in the application 455, based upon selections made, and requirements necessary to generate the estimate. In certain embodiments, the selection offered can be filtered based on answers provided in the application 455.

This process can be repeated in each room affected. Once this is completed, and all of the questions have been answered in a manner that satisfies the requirements of the inspection app 455, the inspector is able to submit the collected information for further processing required to produce an estimate of a total or partial restoration cost of a loss site according to embodiments disclosed herein. In certain embodiments, the estimate comprises an estimate of the restoration cost of the contents of the loss site. At least portions of this subsequent processing and the generating of the estimated total or partial site restoration cost for the loss site based at least partially on the classifications of each of the plurality of articles is conducted via the other portions of the computerized inspection system 400.

In embodiments, the inspector can open the inspection app 455 either from a received dispatch or directly from one of the menus. Once the inspection is completed the inspector can upload the inspection data by one or more methods including via an emailed form or data upload made via the user portal 410. In embodiments, these data may be transmitted to the loss estimate module, reviewed by any number of other functionalities for errors, outliers (e.g., an over or under abundance of items in a room having a particular size, and/or the presence of a lack thereof of certain items typically found in a particular type of room. The information can then be used by the loss estimate module 430 to generate the inspection data 535. In embodiments, the method includes one or more review steps allowing for adjustments via the review module 445.

A distinct advantage of the method disclosed herein is the ability of an inspector to collect information for an estimate is based on an organized series of questions which embody years of experience in the art. The end result is the estimate can be fully supported and evaluated based upon the data collected and substantiating photographs or other data obtained during the on-site inspection, and previous history and trends.

The inspection app 455 is preferably configured to operate on any platform such as, for example, iOS, Android, and the like, and is preferably configured to operate on smart devices 405 such as smartphones, tablets, netbooks and/or the like. However, it is to be understood that these examples are merely the current state of the art, and that these examples are not intended to limit the method disclosed herein. In embodiments, the inspection app 455 may be dispatched or configured for full manual entry, and the inspection and data collection may be performed without network connection, e.g., fully autonomously. During the inspection process, no cellular or Wi-Fi connection is required. Such connection may be subsequently required to push and/or send the collected data to the other portions of the computerized inspection system 400 to produce the estimate. It should be appreciated that data can be transmitted via a direct connection, ethernet, serial communications, parallel communications, Bluetooth®, etc.

Examples of data that may be obtained by, and/or utilized by the Inspection App 455, and/or the computerized inspection system 400 include: 1) Preliminary data such as, for example, client information, insurance carrier, billing, dates, loss site information, contractors to be used, public adjusters, attorneys, and the like; 2) guided questions or question banks which facilitate the on-site inspection may be directed to evaluation of the exterior of the dwelling, the source of the damage, the loss origin, the damage type, a quality rating of the site, the contents storage requirements, and/or the like; 3) other questions may be directed to a room by room contents survey that include photos, exposure levels, testing, cleaning, packing, article selection, moving of the articles back and forth, and/or the like; other characterizations include special handling of the articles including total labor, temporary delivery labor, contents disposal, furniture restoration, furniture refinishing, artwork restoration, piano restoration, piano moving, game table restoration, complex audio and/or visual equipment present, clock restoration, the presence of a safe, home gym equipment moving, restoration, storage, the need for reupholstery, restoration of various appliances, the presence of an aquarium, taxidermy present, and/or the like. Note, these may or may not require a vendor specializing in specific restoration and/or moving techniques.

In embodiments, one or more data fields and input options may be configured via both setup configuration options within the inspection app 455, and the choices made in various fields as the data being collected, and/or may be modified based on previous answers or other settings. For example, documenting heat lines on walls is only necessary if the loss type selected is fire. Such a question is entirely inappropriate and inefficient if a loss type of water is selected. Thus, the field for defining the extent of heat lines is unavailable when the loss type is selected to be water.

The computerized inspection system 400, in general, and the inspection app 455 in particular may be configured to function as a gate keeper, wherein subsequent steps required to finish the method cannot be undertaken until the necessary questions are answered. For example, prior to being able to submit data collected during an inspection, and/or prior to being able to conclude an inspection of a particular loss site or room, the system 400 is configured such that it is necessary that all required fields be completed. For example, a relative location (such as “kitchen”), as compared to the source site, may be required by the inspection app 455 to submit the data for further processing.

In embodiments, the field requirements are dynamically set based upon the various configuration settings which can be controlled with a settings module 460 on a partner device 440, and the data entered in the field. For example, it may be necessary (or required) for the inspector to document the severity of the loss in every room, but again the heat line will only be required during a fire loss.

The method may further include a submission step, wherein the data obtained during the inspection step are submitted to the loss estimate module for further processing via the user portal 410. Data may be processed at least partially by any portion of the computerized inspection system 400. For example, once the data obtained by the inspection app 455 has been submitted via the user portal 410, a web based processing may occur. This processing may be performed on a mobile site such as server 425, as part of the destination function, and may be performed for numerous destinations including generating texts, electronic documents, pdfs, image uploads, spreadsheets, and/or the like. As a result of the destination processing, a significant amount of data may then be stored in one or more remote databases 435 for subsequent processing, and include data captured during the site inspection.

It should be appreciated that, in certain embodiments, all aspects can be embodied as entirely web-based applications. In such embodiments, data can be communicated or submitted using web-based online tools including but not limited to Google® or other such tools.

These data may be stored and/or formatted in a format suitable for use by electronic processing via the loss estimate module. However, such data is typically in an inconvenient format for human viewing. Accordingly, the method may include providing these data and associated documents such as reports and the estimated total or partial site restoration cost 545 for the loss site in a more convenient format for human review, and/or for the use within other systems particular to an end user.

In a reporting step, the system 400 and associated method can be configured to generate various site reports and inspection data 545 and/or various versions of such reports may be generated depending on the intended audience. The data can further comprise a list 465 comprising chargeable activities and/or chargeable articles associated with restoration at the loss site. The restoration cost report comprises all such reports. For example, a full copy including essentially all data collected may be required by an insurance company or attorney, yet a truncated list may be more appropriate for a homeowner, which may not be concerned with the number of boxes and the storage and transportation method associated with each article.

The reports 545 generated by the loss estimate module 430 may be based on one or more templates, and/or may include a programmatic format compatible with the mobile app tool sets and the like. The various reports may be emailed and/or stored for subsequent access according to one or more security concerns and/or access levels of end users.

In embodiments, the method is conducted with the aid of the computerized inspection system and utilizes one or more tables, databases, and/or the like comprising price tables of articles, supplies, labor, and the like to characterize each article, and then generates an estimated site restoration cost 545 for the loss site based at least partially on the classifications of each of the plurality of articles. The method may further associate each item with one or more of these characterizations. Such characterizations include cubic feet or volume occupied by the articles individually, or in total, a visibility level which can be an adjustable parameter such that the application and/or inspector can expand or reduce the number of articles to select from, a room application, attribute charges, whether the services are taxable, and/or the like.

In embodiments, characterization of articles may be accomplished according to a base article, wherein a table/database employs an article definition methodology allowing articles to be defined and grouped in an organized manner, thus creating a unique characterization code or representation. In embodiments, this base code comprises 8-digits and may be associated with one or more of a brief description name, a text name, a full name, a shortened menu selection name and/or the like. In embodiments, the article is characterized according to a Group, Class, Type, and Style. As exemplified herein, a hard dining room chair may be characterized according to a Group-furniture, Class-chair, Type-hard, Style-dining. The characterization code for this may be in numerical format, such as 11020101 and/or may be associated via a descriptive brief name such as FurChaHarDin, which may be further associated with the full name of “dining chair”.

In embodiments, the system 400 and associated method is configured such that the unique code associated with each base article is sufficient to associate a cleaning price for general cleaning, a cubic feet required for transport and storage, the unit type (e.g., per square feet, etc.), packing materials required, and the like, as may be required for the generating of the estimated total or partial site restoration cost for the loss site.

In embodiments, these codes or unique identifiers may be further supplemented with various attributes, wherein a base article can be further defined and characterized via the addition of attributes. Attributes include, but are not limited to, gender, material, finish, embellishment, size, vintage, worth, condition, cleaning level, article unique attributes, and the like. Each attribute can potentially affect the processing price by a fixed amount and/or percentage, and the cubic feet of the base article packing materials. In embodiments, the attributes, once selected, may be identified in the unique identifier, e.g., by a single character and a 2-digit number. The single character identifies the attribute type. For example, “S” is for size and “12” means small. Thus, S12=small. For example, dining room chairs may have an article unique attribute such as side arms. This attribute may or may not affect the restoration cost, volume, etc.

For example, a queen size attribute for a mattresses may be identified as S35. When S35 is chosen, the price of restoration may increase by 30%, and the cubic feet of storage required may increase by 50% relative to a twin-sized base characterizing of a mattress. The designation of a mattress may further result in an automatic charge for a mattress cover in the event of fire damage, and the additional time required to install the cover, which is also included in the final estimated site restoration cost generated by the method. In embodiments, attributes may be combined. For example, a dresser may be both large and vintage. Likewise, one or more attributes of the same type may be included for an article such as dress that is beaded (E36) (where “E” signifies embellishment) with lace trim (E42). Likewise, the method and system is configured such that an article cannot have conflicting attributes. For example, an article cannot be both large and small.

In embodiments, the characterization includes the estimated total or partial site restoration cost for the loss site based at least partially on the estimated total volume occupied by the article during transportation and/or storage. The system 400 is thus configured to estimate the cubic footage of contents both in boxes and individual articles. Cubic feet is a first order attribute when considering storage and vehicle size. Thus, cubic feet is used to determine the number of hours for packing, moving, unloading, moving back, unpacking, and the like. It also can be used to identify vehicle sizes, storage requirements, and other portions of the estimate.

Attribute tables can be assigned to an article. For example, the size table for a mattress may include, a twin size, full size, queen size, king size, etc. However, a size table for a chair may include small, medium large, etc. Thus, the term “large” in different tables may have a different affect on a volume and/or associated price.

In addition, data may include images and additional information collected via the inspection app 455 regarding the loss site, facilitating review of the data.

In embodiments, the system 400 and associated method are configured to allow one or more reviews and/or adjustments. It may be possible to review the settings and values used at any point in the process, and to adjust the values based upon additional information, improper assumptions, and/or changing needs.

In embodiments, a script or other determinations are performed by the loss estimate module 430, in which the information is formatted and/or organized for submission to the adjuster, the homeowner, and/or the like. A pdf of the completed estimate may be prepared as the restoration cost reports 545, and can be sent to the contact on file with the loss estimate portal 550, in addition to these data and/or a copy of the report being stored externally.

In embodiments, the method and system 400 are configured to support producing a list 465 comprising chargeable activities and/or chargeable articles associated with restoration at the loss site, and/or a proprietary estimate utilizing one or more sets of pricing values, algorithms, and settings. In some embodiments, the method is configured to interact with other estimating systems.

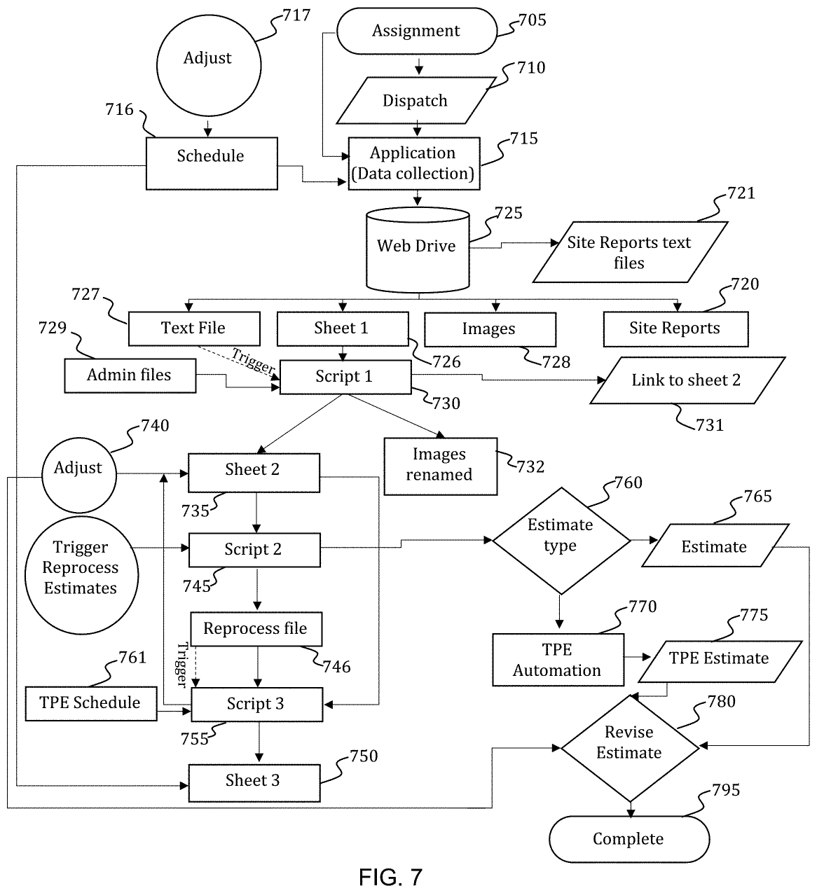

FIG. 7 illustrates a flow chart of steps associated with a loss recovery estimate method 700 in accordance with the disclosed embodiments. It should be appreciated that some or all aspects of the method 700 can be realized with the systems disclosed herein. The method begins at 705, when an assignment is instigated.

An assignment can be instigated in numerous formats. For example, in some embodiments, an insurance adjuster can request a service provider to inspect a loss site for the purpose of preparing an estimate of remediating a home, and the contents within, after a loss due to a fire, water, natural disaster, or other such loss creating event. As a part of the assignment, it may be necessary to collect information to enable a site visit and preparation of the estimate. The type of information necessary to be collected includes, but is not limited to the Insured's name, address, insurance company, adjuster name and contact information, etc. All such information can be collected manually or with a user device 405 and associated user app 455 or user portal 410. It should be appreciated that in certain embodiments, aspects of the user app 455 and/or user portal 410 can be implemented in whole or in part, by either the user app 455, user portal 410, or both, without departing from the scope disclosed herein.

Generally speaking, a job coordinator covers a territory (e.g., a county, city, metroplex, etc.). Thus, the assignment 705 can include assigning a service provider a new service request. Once the loss assignment had been received, a dispatch step 710 is initiated, wherein a service provider can be dispatched to the loss site. In some cases, this can be handled by a job coordinator that will have the necessary loss information to provide the prompted questions from the system 400 to self-calculate the inspection data, job site report and estimate. A loss site visit date and time for the inspection can be coordinated and logged using the calendar module 505. A Job Coordinator (JC) can be selected to make the site visit.

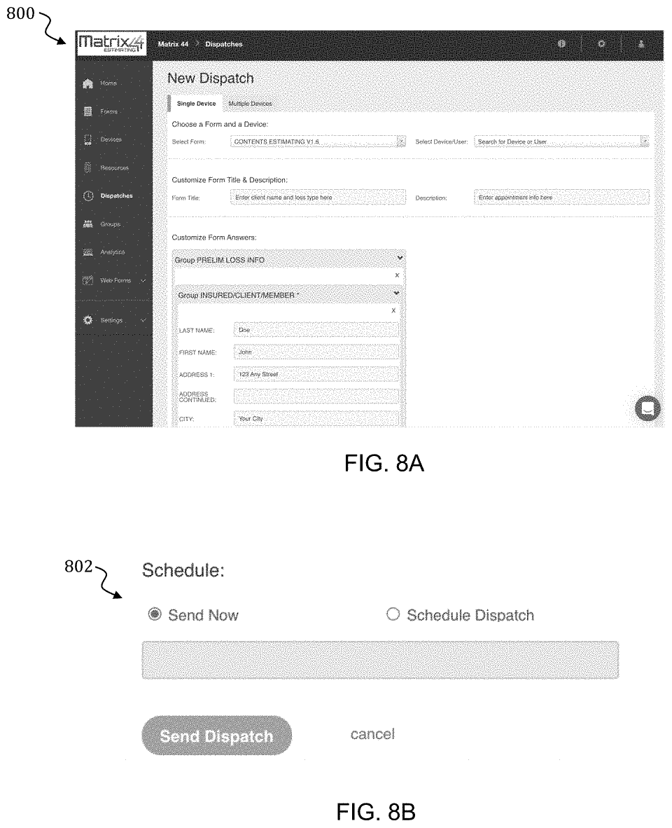

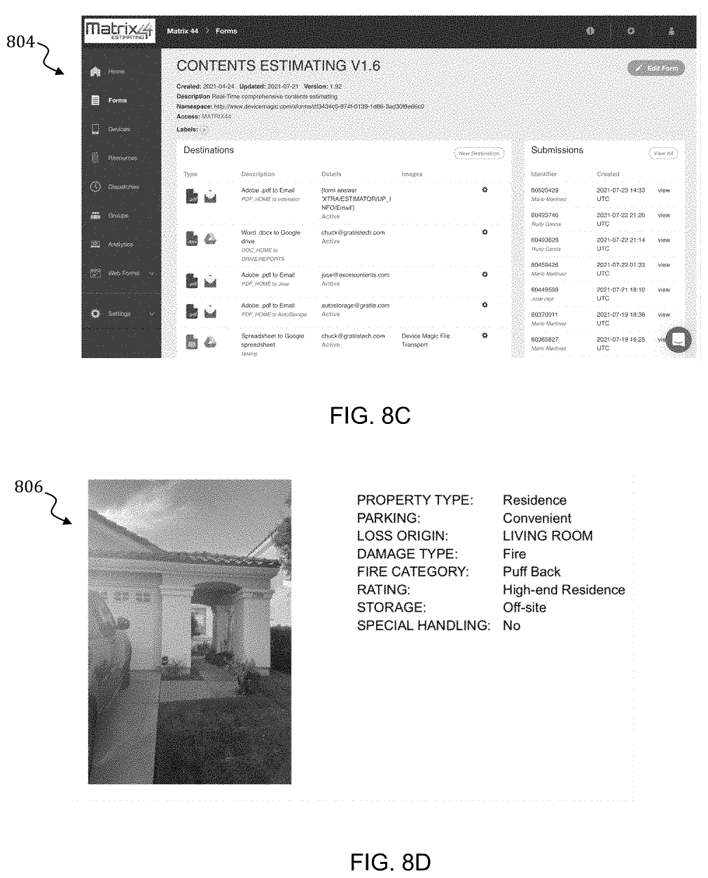

FIG. 8A illustrates a user interface 800 for a new dispatch in accordance with the embodiments disclosed herein. As illustrated the “New Dispatch” form provides options for selecting devices, drop down menus for selections, a form title, and customized form answers, including a group and biographical information regarding the insured/client/member.

The dispatch can be configured to pre-load as much of the data into the system 400 as is known, enabling the estimator to make the appropriate selections on the inspection app 455. For example, if the loss is a fire loss and cleaning, restoration of artwork, antique furniture is needed etc. If the loss was caused by water the estimator will closely inspect the bottom of furniture for possible restoration, repair, or refinish etc. The preset parameters in dispatch will aid in the calculation of extra supervision labor hours, extra labor for moving with a long walking distance to the moving truck when you have a large complex, just to mention a few.

It should be noted that dispatching is not a required step, as all the data can be loaded directly into the inspection app 455 utilizing the smart device 405. However, dispatching makes data entry easier. Dispatching via a desktop computer eases the burden of typing in all the necessary data in the mobile device itself. With the information collected for the assignment, the next step is to open the web portal. The necessary information can then be entered into the web form.

As illustrated in FIG. 8B, the dispatch 802 is either dispatched immediately or scheduled to be sent at a later date/time.

Once the service provider has been dispatched, at step 715 the inspection app 455 is used to collect and record data during a site inspection. A comprehensive schedule 716 (which can be adjusted as illustrated by 717) can be provided to, or stored on, the inspection app 455 providing, for example, a list of article to choose from. A proper amount of information is required in order to calculate an estimate of the cost for remediation. The loss coordinator can collect the pre-prompted questions using the application 455. The coordinator will inspect each of the affected rooms and will enter the articles (furniture items) and number of boxes required to pack the small decorations, figurines, etc. the inspector can also use the application 455 to collect or enter other data such as volumes or areas of articles at the loss site, spaces in the loss site, or of the loss site itself. This process can be repeated in each room affected, or for boxes already packed.

Once the data collection is completed, the coordinator can submit the collected information. The loss estimate module 430 can produce a job-site inspection report, inspection data 535, and estimate 545. The app 715 can include various outputs performed automatically. These can include text 727 to trigger the first script 730 filed in an inputs folder; creation of a drive folder (reports), first sheet 726 (stored in the reports folder), images 728 (stored in the reports folder), site report 720 (sent via email and stored in the drive folder), and a site report home version (sent via email and stored in the reports folder).

It should be appreciated that in certain embodiments, the inspection and data collection can be performed fully autonomously, meaning that during the app 455 operation neither a cellular nor WIFI connection is required until it is time to push the data off the device via Submission.

In certain embodiments, the app 455 can be configured to collect the following categories of information:

PRELIMINARY DATA. In this step preliminary data can be collected. Data can include:

1. Client

2. Insurance Carrier

3. Billing

4. Dates

5. Loss Site Information

6. Contractors

7. Public Adjusters/Attorneys

STEP 1—SITE INSPECTION. In this step inspection of the loss site is completed. Data can include:

1. Exterior

2. Source

3. Loss Origin

4. Damage Type

5. Quality Rating

6. Contents Storage

STEP2—CONTENTS SURVEY. In this step contents of the loss site can be surveyed by room. Data can include:

1. Photos

2. Exposure Level

3. Testing

4. Cleaning

5. Packing

6. Articles

7. Moving

SPECIAL HANDLING. In this step special handling requirements can be documented. Data can include:

1. Total Loss Labor

2. Temporary Delivery Labor

3. Contents Disposal

4. Furniture Restoration

5. Furniture Refinishing

6. Artwork Restoration

7. Piano Restoration

8. Piano Moving

9. Game Table

10. Complex Audio

11. Clock Restoration

12. Safe

13. Home Gym

14. Reupholstery

15. Sub-Zero

16. Aquarium

17. Taxidermy

EXTRA. This includes additional functions provided in the application 455. Data can include:

1. Estimator

2. Documents

3. Settings

4. Configuration

The data fields and input options are configured via both setup configuration options within the app and the choices made in various fields as the data is being collected.

The coordinator can open the app 455 either from a received dispatch or directly from a forms menu. Once the inspection report and estimate are completed the documents can be either emailed directly to the insurance representative and/or can be sent for review to check for any errors and make any adjustments.

Once the collected information has been submitted, further processing occurs at step 725. This processing can be performed in the cloud as part of the destination function. Processing is performed for numerous destinations and can include generating text files, Word docs, pdf creation, image uploads, and the creation of spreadsheets. As a result of the destination processing, some data may be stored and organized on cloud drive 450 as illustrated at step 725. This data can include inspection data, photos, Word® doc files of the site report, pdf output of the site report, full text data of the app, and a spread Sheet (e.g., first sheet 726) containing all the data captured during the site inspection. FIG. 8C illustrates an interface 804 associated with this processing.

As illustrated in FIG. 7, a site report 720 can be generated. In certain embodiments, two versions of the site report 720 are generated. The first is a full copy. The second is a homeowner's version which lacks box counts and list of articles. The site reports 720 can be generated by a populating a template. The template incorporates a programmatic format compatible with the mobile app tool set for variable substitution, if-then statements, for-loops, etc. In certain embodiments, the site report can highlight pricing that has been modified from recommendations. The site report can further include addendums including but not limited to warnings, analysis, and recommended vendor information.

The principal difference in the two site report formats is the amount of data contained in each. The full format contains a full set of all the data whereas the homeowner's version has some data redacted. The site reports can be emailed to company contacts on file and stored on a web drive 725 for future access. This email can be transmitted via the destination processing.

The disclosed embodiment make use of a unique data schedule 716, which serves a wide range of purposes. The schedule 716 can comprise a price table of articles, supplies, labor, etc. The schedule 716 further establishes codes associated with each item. Finally, the schedule 716 defines the cubic feet, visibility level, room application, attribute tables, taxable, etc. the schedule can Interface both with the application 455 and the sheets further detailed herein. The schedule 716 can be adjusted with administrator input as necessary. As such, the schedule 716 comprises a comprehensive database table of articles including suggested price, cu ft, wrap and pack time, attributes modifiers and the like.

The schedule 716 uses an 8 digit base code for each item with possible extension codes providing for attribute description and correlated price and volume adjustments. Articles are defined in a four-level step sequence. The four level definition includes Group, Class, Type, and Style. Each of these steps contribute 2-digits to the 8-digit code. Selections in each of these categories builds the code, a full description, a brief description, etc. The Style can be just “default” or add to the description, etc. For example, Group—Textiles, Class—Garments, Type—Dress and if no Style it would be just that a dress. However, optionally a Style of Ball Gown could be added as further description, which may or may not affect the price, etc.

In an exemplary embodiment, a base article definition methodology provides sufficient information to associate a cleaning price for general cleaning, cubic feet, the unit type, packing materials, etc. Each base article can then further be defined via the addition of attributes. Attributes include but are not limited to gender, material, finish, embellishment, size, vintage, worth, condition, cleaning level, and article unique attributes. Each attribute can potentially affect the processing price and the cubic feet by a fixed amount and/or percentage. Once the attributes are selected, they can be identified by a single character and a 2-digit number. For example, a queen size for mattresses is S35. When S35 is chosen, the price increases by 30% and the cubic feet by 50%. Attributes are entirely optional and can often be combined. For example, a dresser may be both large and vintage. In some cases, it is possible to include more than one attribute of the same type for an article such as beaded (E36) with lace trim (E42). Many attributes cannot have multiple choices for the same article. For example, it is not possible to be both large and small. Attributes add further to the base code, the brief name, menu name, full name, etc. Attributes can be appended to the code such as 11020101S15 to be a Dining Chair Large, (FurChaHarDinLg).

In certain embodiments the first script 730 can exist in the cloud and runs periodically, looking for a text file generated by the web app 725 to arrive in an INPUTS folder. Once triggered, first script 730 takes the data from the first sheet 726 and arranges it in an easier format for human readability which is the second sheet 735.

First Script 730 can comprise an import script configured as a programming script such as a Google® App Script, Java Script, etc. that takes the data contained within the web drive in the first sheet 726 and reorganizes it into a new second sheet 735. The web drive 725 can further store text files 727 which can be a trigger for first script 730, images 728, and site reports 720. The second sheet 735 is easier to view and edit. The first script 730 can intelligently label information utilizing room names and can organize the photos in subdirectories titled with the room names within the second sheet 735 and images directory 728. The second sheet 735 and image subdirectories are stored back on web drive 725. A link 731 to the second sheet can be emailed to the appropriate company contact.

The second sheet 735 is created from a template and can be stored in a folder known as the processed folder. First script 730 makes folders in the Processed Folder for each room. Images are renamed at 732 incorporating the room name in the image title and stored in the Room Folders. A link 731 to the second sheet 735 is sent via email.

The second sheet 735 can be used to provide the necessary data for calculating the estimate details and present the data/images in a user-friendly format. Scripts and settings are stored in a blank master sheet and can be loaded into the individual second sheets 735. The second sheet 735 can thus provide the ability to review and modify the app data in preparation for producing an estimate. The second sheet 735 can include integrated scripting, including second script 745 enabling the necessary subsequent steps to produce an estimate.

As such, the second sheet 735 includes all the data and photos input by the technician in the app 715 in a readable format. Also, if the reprocess function is run via second script 745 then second sheet 735 will include the resultant files necessary to produce the estimate. The methodology and parameters utilized to take the data from within the second sheet 735, are not contained within the second sheet 735 and can be hidden from the user. The information in the second sheet 735 can be adjusted by the user and then reprocessed to adjust the estimate. Estimates can be adjusted without returning to the app. The stored information in second sheet 735 can include 1. INFO, 2. INSURED, 3. PROPERTY, 4. INSURANCE, 5. ESTIMATOR, 6. CONTRACTORS, 7. PA ATTNY, 8. EXTERIOR, 9. ORIGIN, 10. SKETCHES, 11. LOSS TYPE, 12. STEP—1ADD, 13. SPECIALTY, and 14. SPECIALTY LIST, 15. SPECIALTY FOR EACH TYPE (furniture restoration, furniture refinishing, art restoration, etc.), 16. QUICK LIST, 17. DETAIL LIST, 18. QUICK ARTICLE LIST, 19. ARTICLE LIST, 20. ARTICLE PHOTOS, 21. EST MILES, 22. ROOM SUMMARY, 23. INFO FILE, 24. TPE CSV, 25. APP CSV, 26. SHEET FOR EACH ROOM.

A significant factor in the estimate can include use of the cubic footage of contents, both in boxes, and as individual articles. Cubic feet (or other units of volume) can be used as a first order measure utilized thusly in the calculations disclosed herein. The cubic feet helps determine the number of hours for packing, moving, unloading, moving back, unpacking, etc. It also can be used to set vehicle sizes, storage requirements, and other portions of the estimate.

In addition to containing the data necessary for the estimate, the second sheet 735 also contains images and additional information collected via the app 455 at the loss site for easy review. As illustrated at step 740, the settings and values in the second sheet 735 can be reviewed and the values can be adjusted based on additional information or changing needs.

Next, a second script 745 can be initiated from within the second sheet 735. The second script 745 performs the function of taking the information from within the second sheet 735 and formatting an organized invoice ready for submission to the adjuster.

The reprocess 746 can make a text file (i.e., “reprocess”:) and place it in the reprocess folder. This can include client data within the reprocess file. The status in the second sheet 735 can also be set to “Processing”.

The estimate 765 can utilize the data in second sheet 735 (e.g., INFO & MATRIX_CSV sheets) to create an estimate from the sheet data. Second script 745 can create a DOC file using the app scripting. It can also create .doc and .pdf files. The files are stored in the processed folder, and the pdf file can be transmitted via email.

A Third Party Estimate (TPE) can be launched from second script 745 via step 740. The second script makes .csv files out of the INFO & TPE_CSV sheets, and sends the .csv files to the Outputs Folder. The TPE automation 770 can use the information and .csv files to automate a robot for entering (e.g., typing in) the required information to generate an estimate utilizing the selected TPE package.

A file (e.g., a pdf file) of the completed estimate can be prepared and sent to the contact on file as well as stored on web drive 725. It also launches a third script 755 which is not visible to the end user. This third script 755 produces a third sheet 750.

The second sheet 735 can thus provide the ability for the end user to interact with system and modify the data to generate a revised estimate without providing internal data or information.

Once any values are changed within the second sheet 735, the second script 745 can be enacted to update the third sheet 750 with any revised data, recalculate, and then pass the results back to the second sheet 735. Then a revised estimate can be calculated and produced via the second sheet 735. The purpose of the second sheet 735 is to provide a means for users to modify an estimate without sharing the proprietary methods and settings used to arrive at the estimate. The third script 755 takes the values in the third sheet 750 and, after processing, updates the second sheet 735 enabling an estimate revision to be produced.

The third script 755 can be hidden from the end user. In other embodiments, the third script can be accessible to the end user. The third script 755 is triggered from a simple file (reprocess 746) that is generated from the second script 745, when the reprocess menu function is chosen. From that point the third script 755 will function autonomously utilizing second sheet 735, third sheet 750, the schedule 716, and settings contained within the third sheet 750. Once the necessary calculations have been performed within the third sheet 750, then third script 755 will take the results and pass them back to the second sheet 735.

For example, the third script 755 reads in the reprocess file then looks to see if a third sheet 750 exists in the Secured Folder. If not, the third sheet 750 is created from a template. Data from second sheet 735 is uploaded into the third sheet and the schedule 716 is loaded, the appropriate TPE schedule 761 can also be loaded. Two resultant sheets are completed including the INFO and TPE_CSV sheets. The data from these two sheets is passed back to the second sheet 735, and the third sheet 750 is stored in the Secured Folder.

The third script 755, interacting with the third sheet 750, can be used to implement advanced price estimating techniques. This can include calculating labor charges, storage pods, and the like based on the volume of the loss site. These base charges can then be modified by cleaning level, parking convenience, and other such factors. This can further include a breakdown of invoice by work stages with proprietary “settings” such as labor rate to pack the determined cubic feet. The calculations themselves are done with the third script 755 and third sheet 750, which is not accessible to the end user. Profiles can also be applied with the third script 755 and third sheet 750 to negate or substitute charges in accordance with insurance company specific requirements.

The third sheet 750 is similar to the second sheet 735 in that all the values and data from the inspection are contained in both sheets. The primary difference is that the proprietary settings and processing methods are contained only within the third sheet 750 to actually calculate the estimate. Once calculated, the third script passes the final results back to the second sheet 735. The third sheet 750 is hidden from the user and can only exists in secured folders within the cloud. The data from second sheet 735 is passed into third sheet 750 via second script 745. However, third script 755 and third sheet 750 are not visible in the cloud and this is where all the calculations are performed. It should be appreciated that in other embodiments, the third script 755 and third sheet 750 can be made accessible to a user depending on design consideration.

Third sheet 750 can include: 1. EST QUICK, 2. INTEREST QUICK, 3. EST QUICK ARTICLES, 4. INTEREST QUICK ARTICLES, 5. EST DETAIL, 6. INTEREST DETAIL, 7. EST ARTICLES, 8. INTEREST ARTICLES, 9. EST MOVE, 10. CU FT, 11. EST STORE, 12. EST SPECIALTY, 13. INTEREST SPECIALTY, 14. INTER PRE HOURS, 15. INTER INTER PRE HOURS, 16. INTER POST HOURS, 17. INTER MATERIAL, 18. INTER INTER MATERIAL, 19. INTER MATERIAL REPLACE, 20. INTER EST STORE, 21. INTER EST CLEAN, 22. INTER OVERHEAD, 23. INFO, 24. INTER TPE CSV, 25. INTER INTER TPE CSV, 26. TPE CSV, 27. INTER INTER APP CSV 28. APP CSV, 29. SETTINGS, and 30. LOOKUP.

Numerous settings are contained within the third sheet 750, the schedule 716, and the TPE schedules 761. Third sheet 750 settings include for example, general wipe percentages for different loss types and contamination levels, box packing rates (per hour) for various categories and room locations, how many boxes necessary to pack cabinets, etc. based on cabinet type, door, number of shelves, packing density, moving rates based upon parking convenience, loading, and unloading truck rates based upon cubic feet, etc. The schedule 716 can include articles, labor rates, and supplies etc. The TPE schedule 761 can include conversions for a multiplicity of third party estimating platforms.

The disclosed methods and system support producing a proprietary estimate type 760 utilizing pricing values, methods, and settings. In some embodiments, the estimate can be transmitted, and the estimate components and details can be provided to an invoice generating system (e.g., a TPE style invoice utilizing an automation robot). When this format of estimate is performed, the price tables are used, and the end result is a formatted estimate (e.g., an estimate in TPE format) with commensurate pricing.

In certain embodiments advanced pricing techniques can be used. This can include a base charge for each article type with integrated factors including cubic ft, wrap time, disassembly time, packing materials, etc. Extensions to base charges that act as modifiers (dollar & percentage) to both price and volume can be used. It should be understood that such extensions are actually attributes that affect the description, price, volume, etc. of the article code comprising the 8 digits plus optional modifier extensions (e.g., a letter+2 numbers). The schedule 716 can be integrated directly with app 455 and/or third script 750 to compute the estimate. Pricing is essentially unlimited with the use of attributes.

In other embodiments the method for calculating base charges can include assigning a base item per category with a price, and modifying the base for type. This can include relative size, complexity, mixture of cleaning techniques, and the like.

In certain embodiments, the price can be modified by zip code using cost of living or other such information. In certain embodiment, the system can include the ability for each user to assign their own prices.

The estimate 765 provides for notable advantages. In certain embodiments, the estimate 765 can include a street view photo 806 as illustrated in FIG. 8D to refresh viewer which loss site this estimate is for including some of the property and loss information.

Certain aspects of the system can be automated by third party (TPE) platforms as illustrated at 770. Some third party platforms may provide a TPE schedule 761 which can be provided to the third script 755. Thus, in certain embodiments third party automation 770 uses files in second sheet 735, and is embodied as an automation script running as a robot to write the estimate in in a third party format.

There may be multiple TPE schedules 761; one for each TPE that the app provides an integration with. The purpose of the TPE schedule 761 is to provide an interface between schedule 716 items and items available within the TPE platform. This, in essence, will enable an estimate performed with the estimating app to be written in a multitude of TPE formats without the app being rerun. This can include a TPE LIST which can include 1. Group, 2. Code, 3. Description 4. Unit, 5. Est Price, 6. Mapped entries; and an App List that includes 1. App Code, 2. TPE Qty, 3. TPE Group, 4. TPE Code, and 5. TPE exact match.

In certain embodiments, a service is performed by an automation keystroke robot that performs the task of keying in the information. To take advantage of the automation, two files can be used. Both files can be of .csv format (or other similar format). An “info” file includes all the information necessary to complete the estimate with the exception of the actual line item charges. The second file includes the line item charges in a specific format including the group, codes, quantities, override prices, photo links, and flags to control when prices and descriptions are overwritten, etc.

The second sheet 735 can provide an interface to the third party automation 770 by providing the 2 properly configured files necessary for the automation. The second script 745 provides a means of interfacing the files with the proprietary third party automation platforms to then perform the 3^{rd} party automation 770 resulting in estimate 775. It should be appreciated that in other embodiments, a direct application programming interface (API) with the third party invoicing platform can be used.

As illustrated at 780, the estimate can be revised. After running an estimate, it is sometimes necessary to make adjustments. Reasons for revision include something being forgotten and left off the estimate, that the scope of the work changed, or other such reasons. If a revision is required, it will be necessary to open the second sheet 735 to make the adjustments and reprocess 746 using second script 745.

The second sheet 735 provides a means to review the data used in preparing the estimate and the opportunity to make adjustments. The algorithms, settings, and other proprietary information necessary components of the estimate scheme are not continued in the second sheet 735, but reside in the third script 755 and third sheet 750 which are not visible to the user.

Once adjustments are made to the second sheet 735 it is necessary to “submit” the sheet for recalculation. The mechanism for resubmittal is provided in the second sheet 735 via the custom menu which, when enacted, can launch the second script 745. Once triggered, the third script 755 will transmit the revised data to be reprocessed back through to the second sheet 735, thus enabling a revised estimate to be produced by the second script 745. Once the estimate is determined to be accurate it is then submitted to the necessary parties and the process is completed at step 795.

In embodiments, the schedule 716 can include: 1. Style, 2. Base Code, 3. Set attributes, 4. Full Code, 5. App Description, 6. Menu Description, 7. Total Loss Description, 8. Abbreviated Description, 9. Base Price, 10. Final Price, 11. Base Cu Ft, 12. Final Cu Ft, 13., Visibility Level 14. Unit 15. Rooms, 16. Attribute Tables, 17. Material Codes, and 18. Flags. Code schedules can include 1. Group, 2. Class, and 3. Type. The attribute schedules can include: 1. Embellish, 2. Finish, 3. Gender, 4. Level, 5. Material, 6. Size, 7. Vintage, 8. Worth, and 9. Other. Intermediate tables can include 1. Materials, 2. List, and 3. Rooms. The app import can include: 1. Rooms, 2. Visibility, 3. Menu Description, 4. Total Loss Description, 5. App Code, 6. Unit, 7. Flags 8., App Note, 9. Attribute Tables, and 10. UniqueID. In certain embodiments, the App estimate can include 1. App Description, 2. Menu Description, 3. Total Loss Description 4. Price, 5. Unit, 6. CU FT, 7. Flags, 8. Attribute Tables, 9. Import from TPE SCHEDULE, 10. APP LIST.

As illustrated by the aforementioned systems and methods the disclosed embodiments provide a fully supported and easier to “substantiate” estimates. The current embodiments do not rely solely on the “experience” and judgement of the estimator which makes the process of substantiating the estimate difficult. The method of building the estimate from answers to predefined questions and by using predetermined estimate criteria provides a more accurate and easier to evaluate estimate as compared to the current state of the art.

A principal aspect of the disclosed embodiments includes using cubic feet to calculate many components of the estimate which removes guesswork. The cubic feet of the contents is a first order variable in the process for making up the estimate. For example, the cubic feet of contents is directly related to the number of vaults to satisfy any storage requirements. Below is a partial list of the estimate components where the cubic feet can be a factor in determining the estimate costs: Labor Hours (movers), Labor Hours (load truck), Labor Hours (unload truck), Truck (for transportation), Cleaning (labor hours to clean articles), Deodorization, Storage (vaults or pods), Replacement (materials), Labor Hours (move articles), Labor Hours (load truck), Truck (for transportation), and Labor Hours (deliver back). BOXES can include: Labor Hours (packing boxes), Material (packing supplies), Labor Hours (unload truck/boxes), Truck (for transportation), Deodorization (box contents), Cleaning (labor hours to clean box contents), Storage (vaults or pods), Replacement (materials), Labor Hours (move boxes), Labor Hours (load truck), Truck (for transportation), Labor Hours (unpack boxes), Labor Hours (move boxes).

The disclosed methodology of calculating the cubic feet via “detail packing” is another aspect of the disclosed embodiments. In one embodiment for detail packing, numbers can be computed by counting cabinet doors and their sizes, number of shelves, and the packing density which is unique and programmed directly into the app. From these factors the cubic feet of the contents can be estimated, number of boxes necessary, etc. utilizing the proprietary parameters stored in the third sheet 750.

Various methods can be used in association with the detail packing. It should be appreciated that at least one of these methods or any combination thereof can be used in combination.

One option known as a “quick box” method allows the inspector to list the number of boxes and quantities based on their professional judgement. This method is most valuable for a seasoned inspector who is able to list the number of boxes and the quantities required.

Another method, known as “detail boxes” can be used. In this method, the inspector describes the fixture (e.g., top cabinet, bottom cabinet, drawer, pantry, closet, Hutch, or cabinet, etc.) that contains contents, along with a description of how densely the respective fixture is packed. For example, the inspector could list “a top cabinet above a counter, 2 large size doors, 3 shelves in each, and loosely packed.” The system can recognize a top cabinet depth. Using the depth, door size and the number of shelves the system can compute the total volume of the cabinet. Then, using the packing density, the system can estimate the volume of the contents, and from the computed volume, can further determine the number of boxes required. Any number of top cabinets or bottom cabinets with varying door sizes, number of shelves and packing density can be listed within the same room. For example, there might be two double width drawers of single height, which are loosely packed and another double width single height drawer that is jam-packed in the same room. Pantries, closets, etc. can each have differing means for the inspector to identify the fixture thus producing the fixture volume. The packing density modifies the fixture volume to reach the contents volume.

Another method, known as “quick articles” can use generic sizes for articles (small, medium, large, etc.) which can be listed in a room for an approximate calculation.

Finally, a last method known as “detail articles” can be used. In this method a list of specific articles typically found in a room can be individually provided and relevant articles can be selected. The article list to choose from can be filtered for the room type or the entire list can be made available by user selection.

The total cubic feet can be accumulated by multiple methods. The cubic feet includes both boxes and individual articles. The number and size of boxes necessary to pack out (quick boxes) or detail description of cabinets etc. (detail packing). In accounting for articles selecting furniture by size category (quick article) or by selecting the articles precisely (selected articles) is available. Any or all of these methods can be used on any estimate.

Furthermore, the disclosed estimate process automatically transmits detailed information collected via the app directly into the estimate document without rekeying or copying. Once the data has been entered into the app, no additional human intervention is required to complete the proposal. Review and adjustment can take place after the initial estimate is automatically prepared, but is not always required.

As provided herein, attributes are added descriptions that may or may not affect the price. Attributes include but are not limited to Size, Gender, Material, Condition, Level Service, Embellishment, Finish, Vintage, Worth, etc. Adding one or many attributes provides a means of a nearly endless price list without predetermination. An extension code can be associated with each attribute. The extension codes can affect the price via a fixed dollar amount and/or a percentage upcharge to the base price. The extension codes can be combined with each other each affecting the price, cubic feet, etc.

Using attribute pricing methodologies provides for a more clear and defined pricing. For example, in furniture a smaller version of the same article in its standard size might be 25% less expensive to clean. If a new article type is added to the table, just the already defined cost to clean the standard size is necessary to determine the cleaning cost of the new article type by applying any adjustments applicable to the attribute modifiers. The smaller would be 25% less expensive. Similarly, the level of cleaning percentage upcharge would be applied to the base. Thus, to justify the disclosed pricing scheme only standard size article pricing need be considered along with how the modifiers affect the price.

Room classifications in the disclosed schedule as well as the app provide unique enhancements. Articles can be assigned a room type(s) in which they might be found. For example, you would expect to find a bicycle in a storage type room such as a garage or basement, but not a sleeping room. By classifying articles by room type(s) the app will only present to the user for selection, those types of articles found in the room type. This makes for quicker article selection. An override is available to search for an article across all articles such that a bicycle could actually be selected in the master bedroom.

Furthermore, using questions directly related to the site condition to aid in determining the cleaning level (if any) is unique. For example, on fire loses the sweat lines, heat line, odor level, etc. all contribute and substantiate to what level of cleaning will be required in each room.

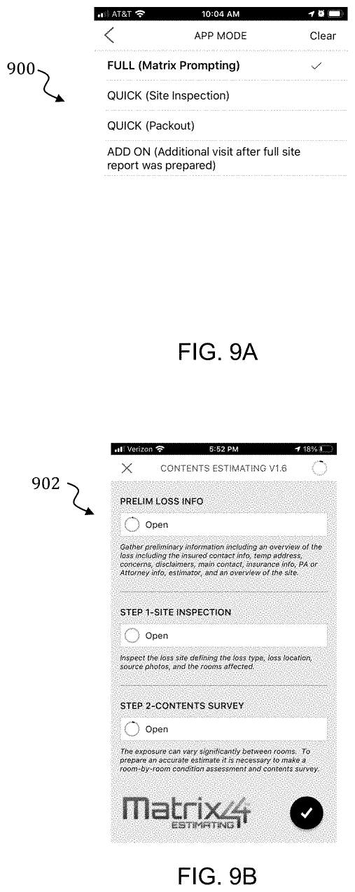

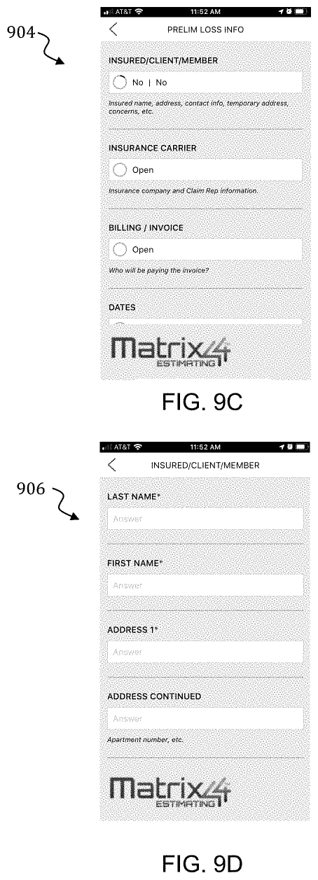

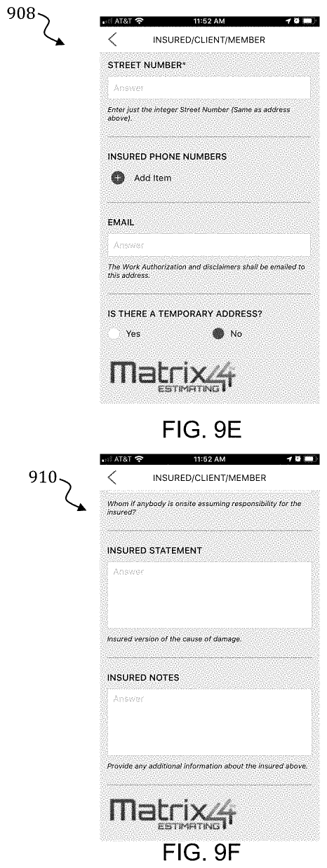

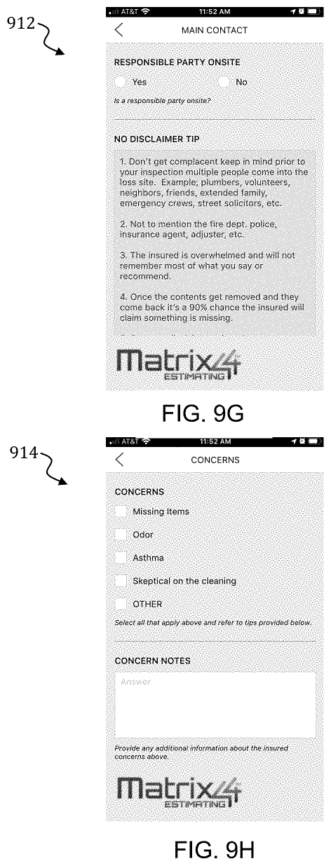

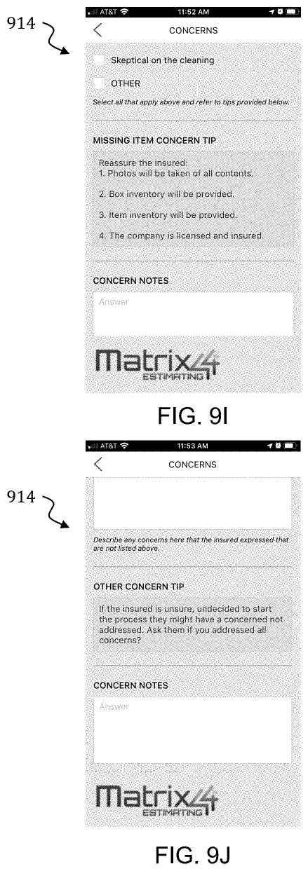

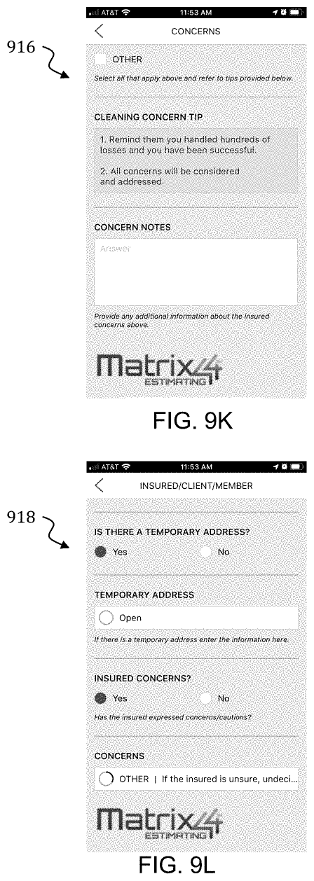

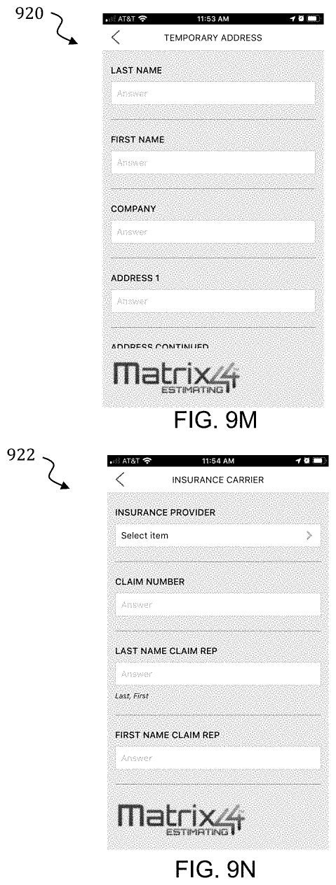

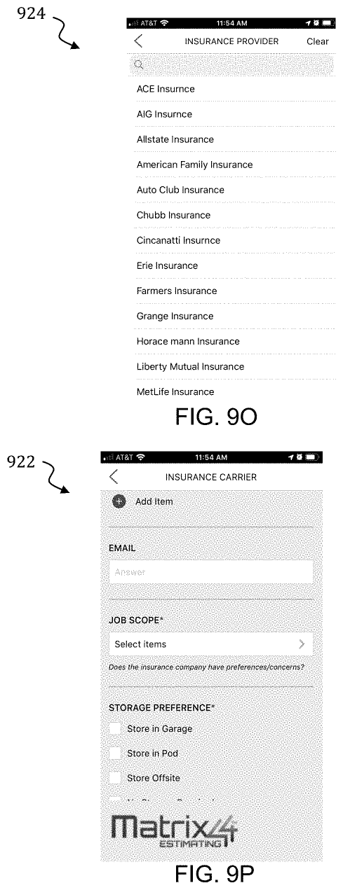

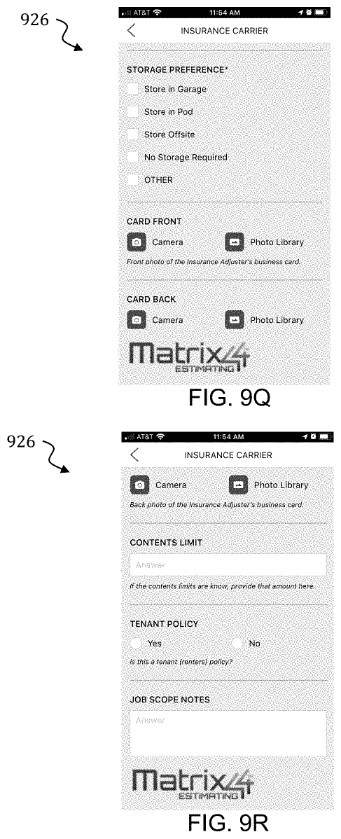

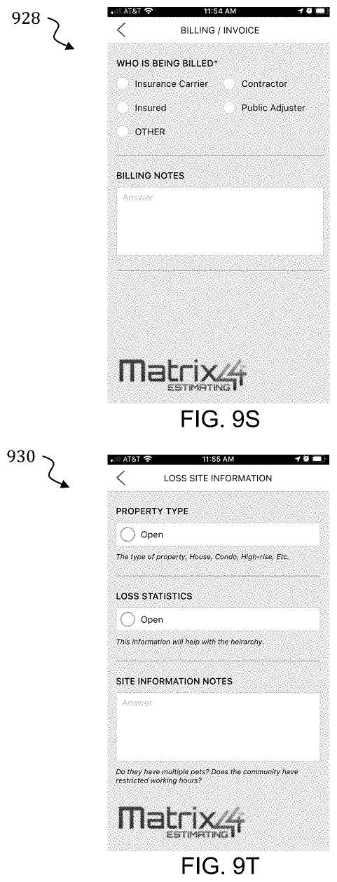

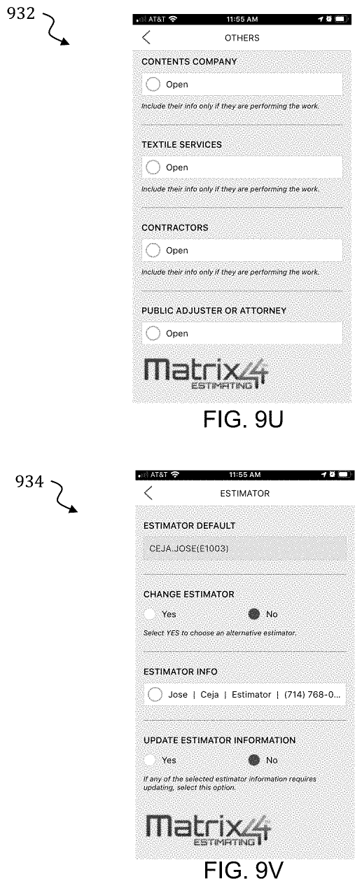

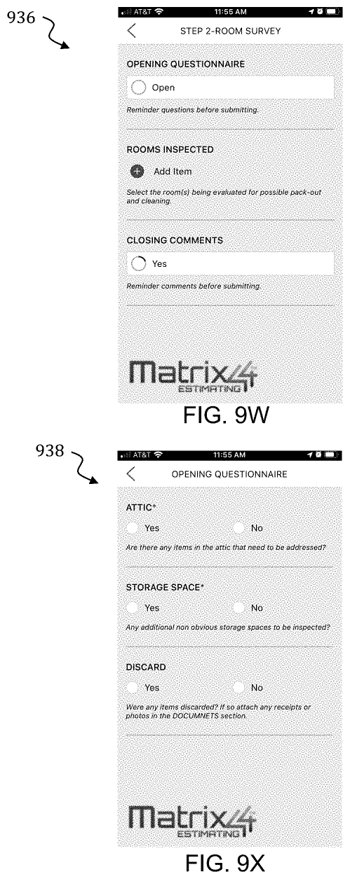

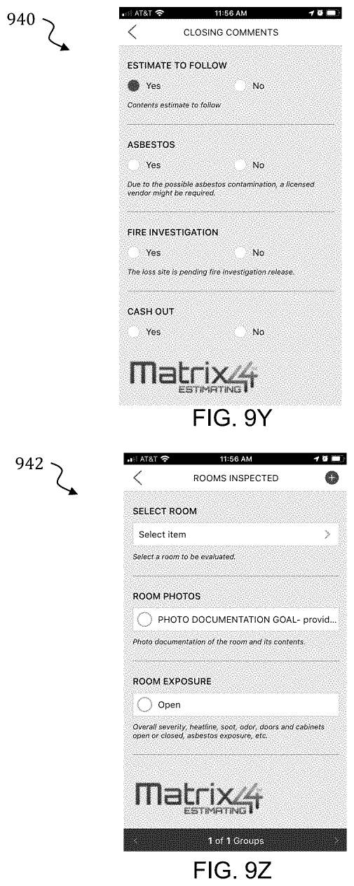

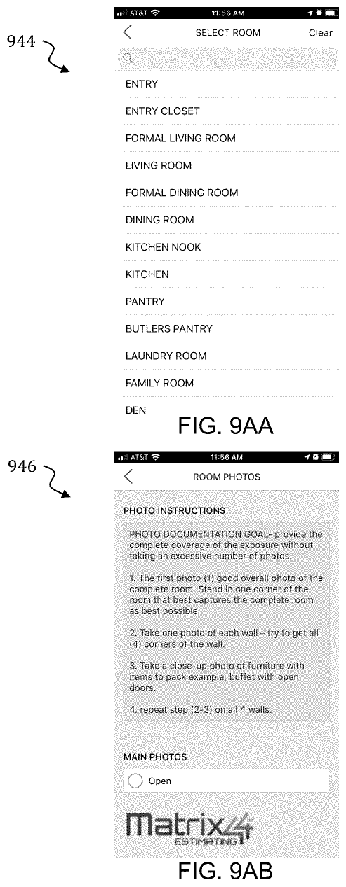

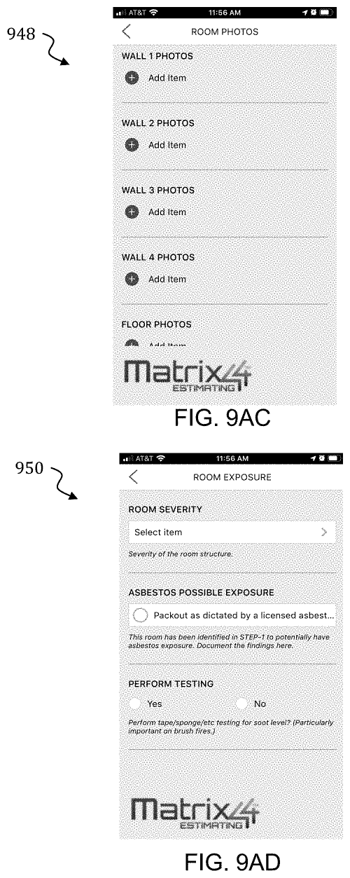

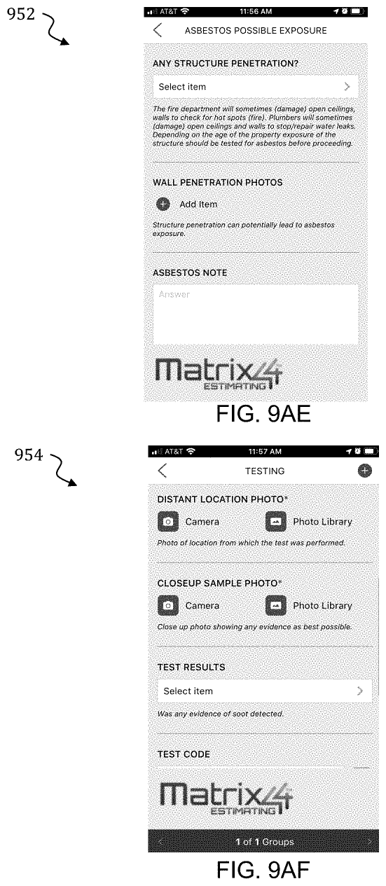

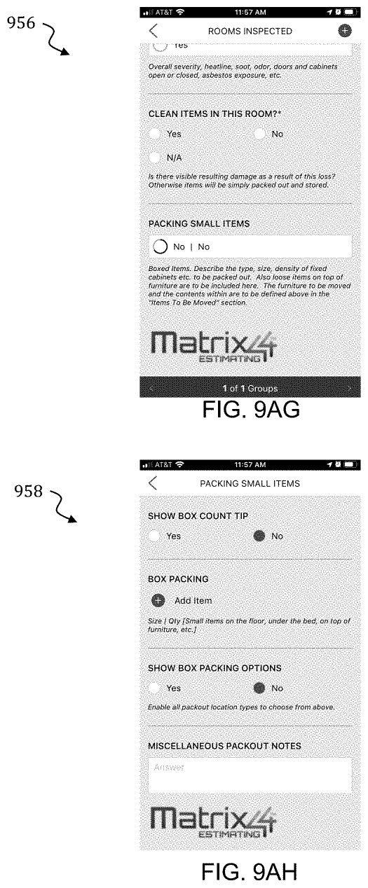

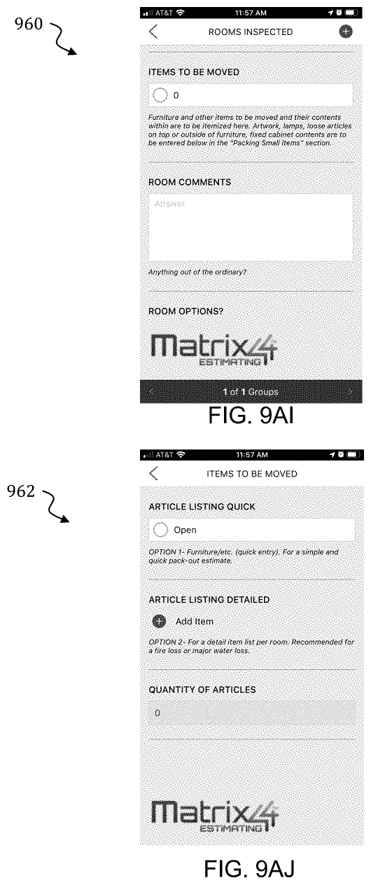

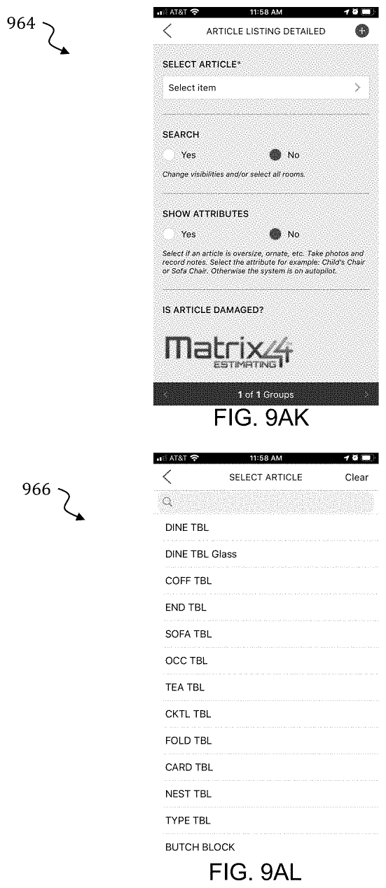

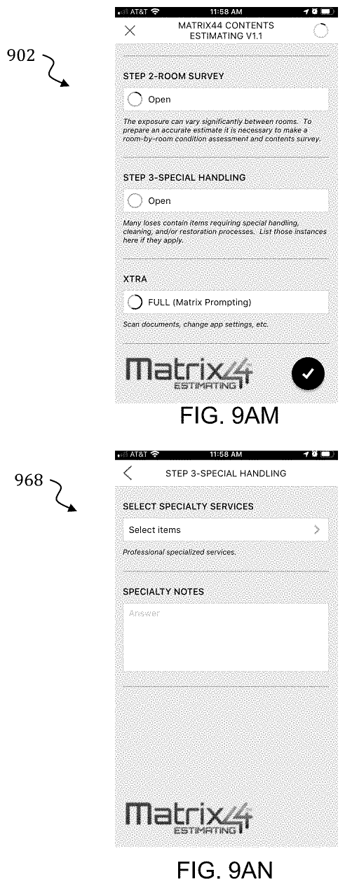

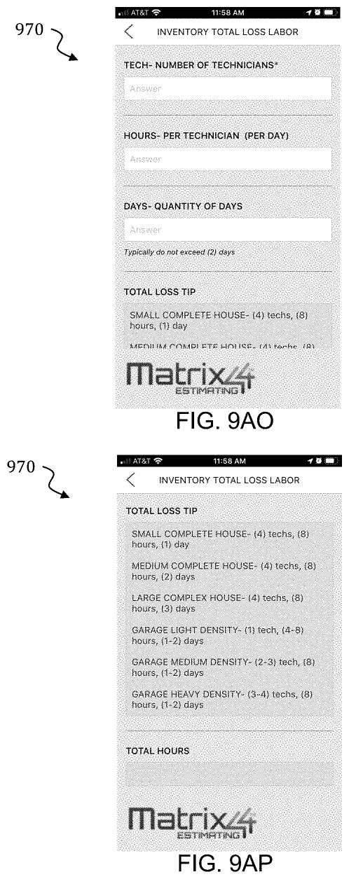

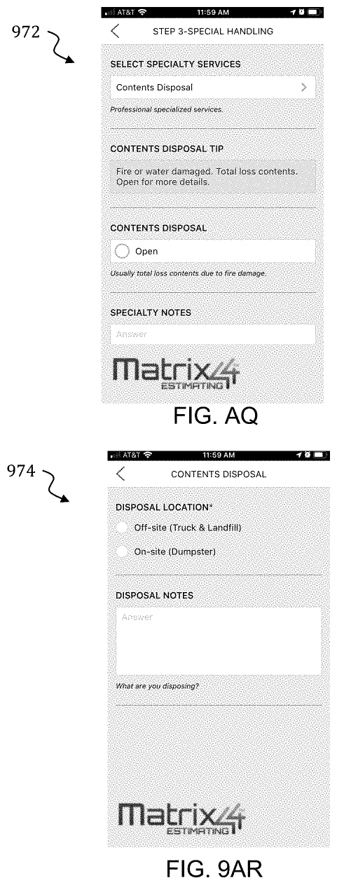

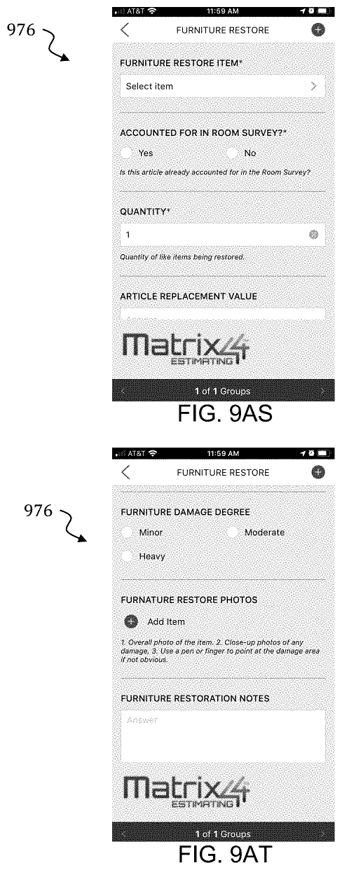

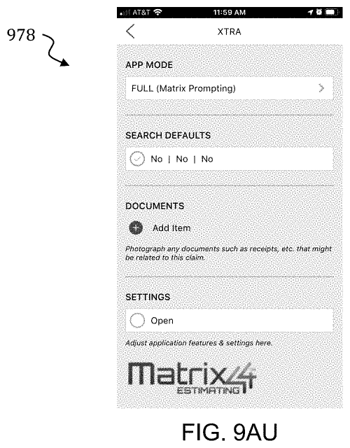

FIGS. 9A-9AU Illustrate aspects of the user portal 410 and/or App 455 in accordance with the disclosed embodiments. Specifically, FIGS. 9A-9AU provide screen shots of the software interface arranged in logical order, illustrating the workflow and use of the application to collect data at a loss site.

FIG. 9A illustrates an introduction screen 900 of an application 455, allowing the estimator to select the mode of the application. Options can include a full walkthrough with prompting, a “quick” site inspection, a “quick” packout, or an add on.

Upon selection, the application 455 can proceed to a progress interface 902 in FIG. 9B, providing selectable options for completing the site inspection. FIG. 9C illustrates a series of selection regarding preliminary loss information including whether the person who suffered the loss is insured, and if so, information relating to the insurance carrier, in interface 904. In interface 906 in FIG. 9D, information relating to the insured/client/member can be entered. In interface 908 in FIG. 9D, address and contact information, along with a button indicating if this is a temporary address can be provided. Insured statements and insured notes can be entered at interface 910 in FIG. 9F.

FIG. 9G includes a main contact information interface 912, which includes a button to indicate if the responsible party is onsite. Disclaimer tips can also be provided.

FIG. 9H illustrates a concerns interface 914, where concerns can be checked, and concern notes can be added. FIG. 9I illustrates additional concerns options in the concerns interface 914 and a field to enter concerns notes. Tips regarding concerns items can be provided. FIG. 9J illustrates further aspects of interface 914 where addition concern notes can be added. FIG. 9K illustrates further aspects of interface 914 where concern notes regarding cleaning matters can be added.

Once the concerns are added, the user can return to interface 918 in FIG. 9L where information regarding a temporary address can be added. At interface 920 of FIG. 9M temporary address information including last name, company and address can be added.

FIG. 9N, illustrates interface 922 where insurance carrier information can be added including the insurance provider, claim number, and claim representative name. In FIG. 9O interface 924 includes a drop down menu of insurance providers sorted by name alphabetically. Interface 922 can further include fields for email address of the insurance provider and a job scope drop down menu as shown in FIG. 9P. FIG. 9Q illustrates interface 926 where the storage preferences can be submitted, and photographs of an insurance adjusters' card can be added. FIG. 9R further illustrates fields for contents limits, tenant policies and job scope notes. FIG. 9S illustrates a billing/invoice interface 928 where buttons are provided to indicate who is being billed and a field is provided for billing notes.

FIG. 9T illustrates a loss site information interface 930. Here the property type and loss statistics pages can be accessed, and site information notes can be entered. FIG. 9U illustrates a similar interface 932 where contents company data can be input, textile services can be selected, contractors' information can be entered, and public adjustor or attorney information can be entered. FIG. 9V illustrates the estimator interface 934 where estimator information can be entered or updated.

FIG. 9W illustrates an interface 936 at the beginning of step 2, which includes the room(s) survey. At this interface the user can select rooms for data collection, and can proceed to the closing comments section. The room survey can begin with the opening questionnaire interface 938, where buttons are provided to indicate if there is an attic, storage space and if any items were discarded as shown in FIG. 9X. FIG. 9Y illustrates the closing comments interface 940, where buttons are provided to indicate if an estimate will follow, if asbestos is present, if fire investigation is included, and whether there will be a cash out.

FIG. 9Z illustrates a room inspection interface 942. Here the user can select a room using a drop down menu 944 as illustrated in FIG. 9AA. Room photo collection and room exposure pages are also accessible here.

FIG. 9AB illustrates the room photo interface 946 where instructions for taking photos are provided and the photo library/photo taking application are accessible. Prompts can be provided for selecting appropriate images as illustrated in interface 948 of FIG. 9AC. Likewise, room exposure data such as the room severity, possible asbestos exposure, and testing completion fields are provided in room exposure interface 950 of FIG. 9AD. If asbestos exposure is possible the user can enter associated information in using interface 952 of FIG. 9AE. This can include a drop down menu to identify items that have been exposed, collection of associated photos and notes. Interface 954 provides photo selection options and a drop down menu of test results where necessary, as shown in FIG. 9AF.

FIG. 9AG illustrates a rooms inspected interface 956 where buttons are provided for indicating if items in the specified room will be cleaned. A prompt to indicate small item packing is also provided. If small item packing is selected, interface 958 provides box count tips if desired, as well as a field to add box packing items, and an option to show box packing items. Notes regarding the packout can be included as illustrated in FIG. 9AH.

In FIG. 9AI the room inspected interface 960 can further provide connection to a configurable list of items that need to be moved, and a field for room comments. FIG. 9AJ illustrates interface 962, where items to be moved can be added, and a running total of such articles can be displayed.

FIG. 9AK illustrates an article listing detail interface 964 where articles can be selected from a drop down menu 966, as shown in FIG. 9AL, and a search indicator is provided. An option is provided to show attributes if desired.

When all the room surveys at step 2 are complete, the system returns to interface 902 to enter step 3 which includes special handling instructions as illustrated in FIG. 9AM. FIG. 9AN shows special handling interface 968, which includes a drop down menu to select specialty services. Specialty notes can also be entered.

Interface 970 in FIG. 9AO illustrates an inventory total loss labor interface 970. Here data regarding the number of technicians required can be entered, along with the hours required per technician, and the number of days required. FIG. 9AP illustrates additional features of the interface 970 including total loss entry tips illustrating standard numbers for various loss types.

FIG. 9AQ illustrates aspects of the special handling interface 972 where specialty services can be selected with a drop down menu. This can include for example, contents disposal, content disposal tips, and associated notes. It should be appreciated that other such specialty services can also be listed. Interface 974 in FIG. 9AR provides fields for entering disposal locations and disposal notes.

FIG. 9AS illustrates a furniture restore interface 976 where a furniture item to be restored can be selected from a drop down menu. The interface includes buttons to indicate if the item was accounted for in the room survey, the number of items and the article replacement value. FIG. 9AT further illustrates aspects of the furniture restore interface 976 where the degree of damage can be indicated, photos of the furniture can be added, and furniture restoration notes can be provided.

The XTRA interface 978 in FIG. 9AU can also be provided. This interface 978 provides a toggle to the desired application mode, provides a menu to set search defaults, provides a document addition option, and provides settings which can be adjusted if necessary.

When the preliminary loss information, step 1 site inspection, and step 2 contents survey has been completed and all relevant information has been collected using the app 455, it is ready for submission to the loss estimate module where the method 700 illustrated in FIG. 7 proceeds for the generation of the desired loss estimates.

It should be appreciated that the interfaces illustrated in FIGS. 9A-9AU are exemplary and various aspects of these interfaces may be provided together or separately in various embodiments. It should further be appreciated that the options illustrated in these figures are provided for reference, but other options and fields can be included in other embodiments.

Estimates produced according to embodiments disclosed herein include a number of advantages over the prior art. The estimated site restoration cost for the loss site generated according to embodiments disclosed herein is based at least partially on the classifications of each of the plurality of articles. The estimate may include street view photo to refresh viewer which loss site this estimate is for, including some of the property and loss information. They may be organized and easy to review, and are based on objective evidence in a methodical and reproducible way. They are grounded in fact and not mere impression. Embodiments of the method and system disclosed herein are fully supported and easier to “substantiate” than current state of the art estimates. Unlike typical estimates common in the art, the estimated site restoration cost for the loss site generated by the instant method, by being based at least partially on the classifications of each of the plurality of articles, do not rely solely on the “experience” and judgement of the estimator, which makes the process of substantiating the estimate difficult. Instead, the method utilizes a methodology in which the estimate is built from answers to predefined questions and using proven algorithms and settings that embody years of experience. The method thus provides a more accurate estimate and one that is easier to evaluate than anything known in the art.

It should be appreciated that according to the embodiments disclosed herein the restoration cost can be related to the scope of the inspection. For example, the embodiments disclosed herein can be applied to all facets of the restoration process including contents of the loss site, as well as structures or other aspects associated with the loss site.

In embodiments, the cubic feet occupied by the articles is used to calculate many components of the estimate and removes much of the guesswork. The method employs algorithms in which the cubic feet of the contents may be directly related to the number of vaults to satisfy any storage requirements. Other factors that may be included in the estimate which may be associated with the volume occupied by the articles, the weight of the articles, the linear feet etc., via various characterizations include: labor hours for the movers, labor hours for loading and unloading the moving truck, the size of the truck needed for transportation, the costs associated with cleaning including labor hours to clean articles, deodorization and the like; the size of storage vaults or pods required, the cost of replacement materials needed, the labor hours to move and/or position the articles at various stages of the process, the number of boxes required, including labor hours for packing, packing supplies required, both type and amount, labor hours for unloading at the storage site, and others.

Based on the foregoing, it can be appreciated that a number of embodiments, preferred and alternative, are disclosed herein. For example in certain embodiments, a system comprises a computer system, the computer system further comprising: at least one processor; a graphical user interface; and a computer-usable medium embodying computer program code, the computer-usable medium capable of communicating with the at least one processor, the computer program code comprising instructions executable by the at least one processor and configured for: receiving inspection data from a loss site, comprising data representing an inventory of at least a portion of articles present at the loss site, determining from these data a classification for each of the plurality of articles identified in the inventory according to predetermined classification criteria, and generating an estimated restoration cost for the loss site based at least partially on the classifications of each of the plurality of articles.

In an embodiment the system further comprises, a user device, the user device comprising a GPS receiver, a camera, and a computer system, the computer system further comprising: at least one processor, a graphical user interface; and a computer-usable medium embodying computer program code, the computer-usable medium capable of communicating with the at least one processor, the computer program code comprising instructions executable by the at least one processor and configured for: receiving data associate with the loss site, and generating the inspection data from the loss site, comprising data representing an inventory of at least a portion of articles present at the loss site.

In an embodiment, each classification includes an estimated total volume occupied by the article during transportation and/or storage, and wherein the restoration cost for the loss site is based at least partially on a total volume occupied by the articles. In an embodiment, the classification comprises an estimated restoration cost of the article, based on predetermined values.

In an embodiment, the inspection data further comprises a type of loss, and wherein the estimated restoration cost of the article is partially based on the type of loss. In an embodiment, the inspection data further comprises a geographic location of the loss site, and wherein the estimated restoration cost is at least partially based on the geographic location of the loss site.

In an embodiment, each of the articles identified in the inventory includes a relative location of the article at the loss site, and wherein the estimated restoration cost is at least partially based on the relative location of each of the articles at the loss site.

In an embodiment the system further comprises obtaining a total area of each of the relative locations present at the loss site, and wherein the estimated restoration cost is at least partially based on the total area of the relative locations present at the loss site.

In an embodiment, the relative location of the article at the loss site includes an elevation of the location of the article relative to a ground level, a distance from the location of the article to an access point of the loss site, or a combination thereof.

In an embodiment, the classification of each of the plurality of articles comprises a base designation indicating a plurality of attributes of the article.

In another embodiment, the method of estimating a restoration cost of a loss site, comprises obtaining inspection data from the loss site, comprising data representing an inventory of at least a portion of articles present at the loss site, determining from these data a classification for each of the plurality of articles identified in the inventory according to predetermined classification criteria, and generating an estimated restoration cost for the loss site based at least partially on the classifications of each of the plurality of articles.

In an embodiment of the method, each classification includes at least one of an estimated total volume occupied by the article during transportation and/or storage, and wherein the restoration cost for the loss site is based at least partially on a total volume occupied by the articles and an estimated restoration cost of the article, based on predetermined values.

In an embodiment of the method the inspection data further comprises at least one of a type of loss, wherein the estimated restoration cost of the article is partially based on the type of loss, a geographic location of the loss site, wherein the estimated restoration cost is at least partially based on the geographic location of the loss site, and a relative location of the article at the loss site, wherein the estimated restoration cost is at least partially based on the relative location of each of the articles at the loss site.

In an embodiment the method further comprises obtaining a total area of each of the relative locations present at the loss site, and wherein the estimated restoration cost is at least partially based on the total area of the relative locations present at the loss site.

In an embodiment, the classification of each of the plurality of articles comprises a base designation indicating a plurality of attributes of the article, wherein the base designation comprises at least one of: a plurality of predetermined indicating sets of text characters, numeric characters, or a combination thereof, arranged in a particular order wherein both the content of the set and a location of the set within the base designation are indicative of the attributes of the article according to predetermined criteria plurality of pre, determined indicating sets, each comprising characters or numbers, arranged sequentially to represent at least a group, a class, a type, and/or a style of the article according to predetermined criteria, and a plurality of predetermined indicating sets, each comprising one or more numeric characters arranged to sequentially to represent specific attributes of the article according to predetermined criteria.

In an embodiment, the classification further comprises one or more additional attribute sets and/or fields appended to the base designation, wherein the content of the attribute sets represent features of the article in addition to those indicated by the base designation according to predetermined criteria and wherein the attribute sets indicate a relative size of the article, a level of complexity of the article, a level of contamination present on the article, a material from which the article is constructed, a shape of the article, or a combination thereof.

In an embodiment, the inspection data from the loss site is at least partially generated during an on-site inspection conducted by an inspector present at the loss site utilizing a computerized inspection system configured to present a series of questions to the inspector, and to receive a corresponding series of answers from the inspector, to provide the inventory of at least a portion of articles present at the loss site.

In an embodiment of the method the computerized inspection system presents the series of questions to the inspector and receives the answers from the inspector via a graphical user interface comprising a plurality of menus, drop down selections, buttons, data entry fields, barcode entry fields, image recognition, voice translation, photographic image entry fields, freehand drawing fields, or a combination thereof.

In an embodiment, the method further comprise a review step, wherein one or more data utilized to generate the estimated restoration cost for the loss site may be revised, and another estimated restoration cost for the loss site generated based on the revised data; and saving any portion of the data utilized to generate the estimated restoration cost for the loss site in an electronic database.

In another embodiment, a system comprises a computer system, the computer system further comprising: at least one processor; a graphical user interface; and a computer-usable medium embodying computer program code, the computer-usable medium capable of communicating with the at least one processor, the computer program code comprising instructions executable by the at least one processor and configured for: receiving inspection data from a loss site, comprising data representing an inventory of at least a portion of articles present at the loss site, determining from these data a classification for each of the plurality of articles identified in the inventory according to predetermined classification criteria, generating an estimated restoration cost for the loss site based at least partially on the classifications of each of the plurality of articles; and generating an estimated restoration cost of the article, based on predetermined values.

In an embodiment, a system comprises a computer system, the computer system further comprising: at least one processor; a graphical user interface; and a computer-usable medium embodying computer program code, the computer-usable medium capable of communicating with the at least one processor, the computer program code comprising instructions executable by the at least one processor and configured for: receiving data representing an inventory of at least a portion of articles present at a loss site; determining from these data a classification for each of the plurality of articles identified in the inventory according to predetermined classification criteria; and generating a list comprising at least one of: chargeable activities and chargeable articles associated with restoration at the loss site. In an embodiment, the computer program code comprising instructions executable by the at least one processor is further configured for: generating an estimated restoration cost for the loss site based at least partially on the classifications of each of the plurality of articles. In an embodiment, the system further comprises: a user device, the user device comprising a GPS receiver, a camera, and a computer system, the computer system further comprising: at least one processor; a graphical user interface; and a computer-usable medium embodying computer program code, the computer-usable medium capable of communicating with the at least one processor, the computer program code comprising instructions executable by the at least one processor and configured for: collecting data associate with the loss site; and transmitting data representing an inventory of at least a portion of articles present at the loss site. In an embodiment, each classification includes an estimated volume occupied by the article. In an embodiment, the classification comprises: an estimated restoration cost of the article, based on predetermined values. In an embodiment, the estimated restoration cost further comprises: a type of loss, wherein the estimated restoration cost of the article is partially based on the type of loss. In an embodiment, the estimated restoration cost further comprises: a geographic location of the loss site, wherein the estimated restoration cost is at least partially based on the geographic location of the loss site. In an embodiment, each of the plurality articles identified in the inventory includes a relative location of the article at the loss site, and wherein the estimated restoration cost is at least partially based on the relative location of each of the articles at the loss site. In an embodiment, the computer program code comprising instructions executable by the at least one processor is further configured for: obtaining a total area of each of the relative locations present at the loss site, and wherein the estimated restoration cost is at least partially based on the total area of the relative locations present at the loss site. In an embodiment, the relative location of the article at the loss site includes an elevation of the location of the article relative to a ground level, a distance from the location of the article to an access point of the loss site, or a combination thereof. In an embodiment, the classification of each of the plurality of articles comprises a base designation indicating a plurality of attributes of the article. In an embodiment, the computer program code comprising instructions executable by the at least one processor is further configured for: determining a volume of packing space based on a description of a space taken from the data.

In an embodiment, a method of estimating a restoration cost of a loss site, comprises: obtaining data representing an inventory of at least a portion of articles present at a loss site; determining from these data, a classification for each of the plurality of articles identified in the inventory according to predetermined classification criteria; and generating a list comprising at least one of: chargeable activities and chargeable articles associated with restoration at the loss site. In an embodiment, each classification includes at least one of: an estimated volume occupied by the article and an estimated restoration cost of the article, based on predetermined values. In an embodiment, the method comprises generating an estimated restoration cost for the loss site based at least partially on the classifications of each of the plurality of articles. In an embodiment, the method further comprises at least one of: estimating the restoration cost for the loss site based at least partially on a type of loss; estimating restoration cost for the loss site based at least partially on a geographic location of the loss site; and estimating restoration cost for the loss site base at least partially on a relative location of the article at the loss site. In an embodiment, the method further comprises: obtaining a total area of each of the relative locations present at the loss site; and estimating restoration cost for the loss site at least partially based on the total area of the relative locations present at the loss site. In an embodiment, the classification of each of the plurality of articles comprises a base designation indicating a plurality of attributes of the article, wherein the base designation comprises at least one of: a plurality of predetermined indicating sets of text characters, numeric characters, or a combination thereof, arranged in a particular order wherein both the content of the set and a location of the set within the base designation are indicative of the attributes of the article according to predetermined criteria; a plurality of predetermined indicating sets, each comprising characters or numbers, arranged sequentially to represent at least a group, a class, a type, and/or a style of the article according to predetermined criteria; and a plurality of predetermined indicating sets, each comprising one or more numeric characters arranged sequentially to represent specific attributes of the article according to predetermined criteria. In an embodiment, the method further comprises: generating inspection data, and an inspection report, wherein the inspection data from the loss site is at least partially generated from an on-site inspection conducted at the loss site utilizing a computerized inspection system configured to present a series of questions to an inspector.

In an embodiment a system comprises: a computer system, the computer system further comprising: at least one processor; a graphical user interface; and a computer-usable medium embodying computer program code, the computer-usable medium capable of communicating with the at least one processor, the computer program code comprising instructions executable by the at least one processor and configured for: receiving data representing an inventory of at least a portion of articles present at a loss site; determining from these data, a classification for each of the plurality of articles identified in the inventory according to predetermined classification criteria, wherein the classification of each of the plurality of articles comprises a base designation indicating a plurality of attributes of the article; generating a list comprising at least one of: chargeable activities and chargeable articles associated with restoration at the loss site; and generating an estimated restoration cost, based on predetermined values associated with the list.

It should be appreciated that variations of the above-disclosed and other features and functions, or alternatives thereof, may be desirably combined into many other different systems or applications. It should be understood that various presently unforeseen or unanticipated alternatives, modifications, variations, or improvements therein may be subsequently made by those skilled in the art which are also intended to be encompassed by the following claims.

What is claimed is:

1. A system comprising:
a computer system, the computer system further comprising:
at least one processor;
a graphical user interface; and
a computer-usable medium embodying computer program code, the computer-usable medium capable of communicating with the at least one processor, the computer program code comprising instructions executable by the at least one processor and configured for:
receiving data representing an inventory of at least a portion of articles present at a loss site;
determining from these data a classification for each of the plurality of articles identified in the inventory according to predetermined classification criteria; and
generating a list comprising at least one of: chargeable activities and chargeable articles associated with restoration at the loss site.

2. The system of claim 1 wherein the computer program code comprising instructions executable by the at least one processor is further configured for:
generating an estimated restoration cost for the loss site based at least partially on the classifications of each of the plurality of articles.

3. The system of claim 1 further comprising:
a user device, the user device comprising a GPS receiver, a camera, and a computer system, the computer system further comprising:
at least one processor;
a graphical user interface; and
a computer-usable medium embodying computer program code, the computer-usable medium capable of communicating with the at least one processor, the computer program code comprising instructions executable by the at least one processor and configured for:
collecting data associate with the loss site; and
transmitting data representing an inventory of at least a portion of articles present at the loss site.

4. The system of claim 1, wherein each classification includes an estimated volume occupied by the article.

5. The system of claim 1, wherein the classification comprises:
an estimated restoration cost of the article, based on predetermined values.

6. The system of claim 5, wherein the estimated restoration cost further comprises:
a type of loss, wherein the estimated restoration cost of the article is partially based on the type of loss.

7. The system of claim 5, wherein the estimated restoration cost further comprises:
a geographic location of the loss site, wherein the estimated restoration cost is at least partially based on the geographic location of the loss site.

8. The system of claim 1, wherein each of the plurality articles identified in the inventory includes a relative location of the article at the loss site, and wherein the estimated restoration cost is at least partially based on the relative location of each of the articles at the loss site.

9. The system of claim 8, wherein the computer program code comprising instructions executable by the at least one processor is further configured for:
obtaining a total area of each of the relative locations present at the loss site, and wherein the estimated restoration cost is at least partially based on the total area of the relative locations present at the loss site.

10. The system of claim 8, wherein the relative location of the article at the loss site includes an elevation of the location of the article relative to a ground level, a distance from the location of the article to an access point of the loss site, or a combination thereof.

11. The system of claim 1, wherein the classification of each of the plurality of articles comprises a base designation indicating a plurality of attributes of the article.

12. The system of claim 1, wherein the computer program code comprising instructions executable by the at least one processor is further configured for:
determining a volume of packing space based on a description of a space taken from the data.

13. A method of estimating a restoration cost of a loss site, comprising:
obtaining data representing an inventory of at least a portion of articles present at a loss site;
determining from these data, a classification for each of the plurality of articles identified in the inventory according to predetermined classification criteria; and
generating a list comprising at least one of: chargeable activities and chargeable articles associated with restoration at the loss site.

14. The method of claim 13, wherein each classification includes at least one of:
an estimated volume occupied by the article; and
an estimated restoration cost of the article, based on predetermined values.

15. The method of claim 13 further comprising:
generating an estimated restoration cost for the loss site based at least partially on the classifications of each of the plurality of articles

16. The method of claim 15, further comprising at least one of:
estimating the restoration cost for the loss site based at least partially on a type of loss;
estimating restoration cost for the loss site based at least partially on a geographic location of the loss site; and
estimating restoration cost for the loss site base at least partially on a relative location of the article at the loss site.

17. The method of claim 15, further comprising:
obtaining a total area of each of the relative locations present at the loss site; and
estimating restoration cost for the loss site at least partially based on the total area of the relative locations present at the loss site.

18. The method of claim 13, wherein the classification of each of the plurality of articles comprises a base designation indicating a plurality of attributes of the article, wherein the base designation comprises at least one of:
a plurality of predetermined indicating sets of text characters, numeric characters, or a combination thereof, arranged in a particular order wherein both the content of the set and a location of the set within the base designation are indicative of the attributes of the article according to predetermined criteria;
a plurality of predetermined indicating sets, each comprising characters or numbers, arranged sequentially to represent at least a group, a class, a type, and/or a style of the article according to predetermined criteria; and
a plurality of predetermined indicating sets, each comprising one or more numeric characters arranged sequentially to represent specific attributes of the article according to predetermined criteria.

19. The method of claim 13 further comprising:
generating an inspection report, wherein the inspection report of the loss site is at least partially generated from an on-site inspection conducted at the loss site utilizing a computerized inspection system configured to present a series of questions to an inspector.

20. A system comprising:
a computer system, the computer system further comprising:
at least one processor;
a graphical user interface; and
a computer-usable medium embodying computer program code, the computer-usable medium capable of communicating with the at least one processor, the computer program code comprising instructions executable by the at least one processor and configured for:
receiving data representing an inventory of at least a portion of articles present at a loss site;
determining from these data, a classification for each of the plurality of articles identified in the inventory according to predetermined classification criteria, wherein the classification of each of the plurality of articles comprises a base designation indicating a plurality of attributes of the article;
generating a list comprising at least one of: chargeable activities and chargeable articles associated with restoration at the loss site; and
generating an estimated restoration cost, based on predetermined values associated with the list.
